(19) United States
(12) Patent Application Publication
(10) Pub. No.: US 2010/0014106 A1
(43) Pub. Date: Jan. 21, 2010

(54) PAINT DEALING SYSTEM, PAINT DEALING METHOD, AND COMPUTER

(75) Inventor: Jun Hoshii, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/503,715

(22) Filed: Jul. 15, 2009

(30) Foreign Application Priority Data
Jul. 15, 2008 (JP) 2008-184248
Jun. 10, 2009 (JP) 2009-139459

(51) Int. Cl. H04N 1/60; G06Q 30/00; G06Q 10/00; G06F 17/30; G06Q 50/00; G06Q 20/00; G06K 9/00

(52) U.S. Cl. 358/1.9; 705/26; 705/28; 705/34; 705/400; 707/104.1; 382/165; 707/E17.044

(57) ABSTRACT

A paint dealing system includes computers which are provided for a purchaser, a distributor, and an agency store and are connected to each other via a communication line, wherein the computer of the agency store includes a sample printing unit that prompts a printing apparatus to print a paint sample, and an information printing unit that prints identification information on the sample to identify the paint and the agency store, wherein the computer of the purchaser includes a purchasing unit that transmits the identification information printed on the sample to the computer of the distributor, and wherein the computer of the distributor includes a specification unit that specifies the paint and the agency store which prints the sample on the basis of the transmitted identification information, a charging unit that charges a cost of the specified paint to the purchaser, and a payment unit that pays a cost of printing the sample to the specified agency store.

This application claims priority to Japanese Patent Application No. 2008-184248, filed Jul. 15, 2009 and Japanese Patent Application No. 2009-139459, filed Jun. 10, 2009. The entirety of each of the aforementioned applications are incorporated herein by reference.

### BACKGROUND

1. Technical Field

The present invention relates to a paint dealing system, a paint dealing method, and a sales accounting system, and more particular to a paint dealing system in which the paint or merchandise is purchased via an agency store, a paint dealing method, and a computer.

2. Related Art

An on-demand printing system is proposed in which, when printing is needed, a customer requests as much printing as is needed and the price corresponding to the amount of printing is charged (refer to JP-A-2006-146687). In this case, the customer may pay the price of the printed materials in a scheme of charging the cost by including it with the printing service. The printing vendor can make a profit by absorbing the costs of the materials and the service necessary for printing into the price.

However, it is conceivable that the printed materials are used in dealing but does not become a transaction object. For example, a merchandise catalog or the like would not be the transaction object. In such a case, the price for the merchandise catalog is not directly paid by the purchaser. When the merchandise catalog is printed on demand, the printing vendor who prints the merchandise catalog which actually generates sales of the merchandise should be paid more than the printing vendor who does not generate any merchandise sales. In this case, even though the above-mentioned technique is applied, there is a problem that the printing vendor (agency store) who prints the printed material cannot receive a proper price.

### SUMMARY

An advantage of some aspects of the invention is to provide a paint dealing system in which an agency store can be properly paid, a paint dealing method, and a computer.

According to an aspect of the invention, there is provided a paint dealing system including computers which are provided for a purchaser, a distributor, and an agency store and are connected to each other via a communication line. The computer of the agency store includes a sample printing unit that prompts a printing apparatus to print a paint sample, and an information printing unit that prints identification information on the sample to identify the paint and the agency store. The computer of the purchaser includes a purchasing unit that transmits the identification information printed on the sample to the computer of the distributor. In addition, the computer of the distributor includes a specification unit that specifies the designated paint and the agency store which prints the sample on the basis of the transmitted identification information, a charging unit that charges a cost of the specified paint to the purchaser, and a payment unit that pays a cost of printing the sample to the specified agency store.

### BRIEF DESCRIPTION OF THE DRAWINGS

The invention will be described with reference to the accompanying drawings, wherein like numbers reference like elements.

FIG. 1 is an overall configuration diagram illustrating a paint dealing system.

FIG. 2 is a block diagram illustrating a hardware configuration of a computer.

FIG. 3 is a block diagram illustrating a software configuration of a paint dealing system.

FIG. 4 is a flowchart illustrating entire processes performed by a paint dealing system.

FIG. 5 is a flowchart illustrating a sample sheet printing process.

FIG. 6 is a view illustrating an example of a UI image for designating a paint.

FIG. 7 is a view illustrating print data.

FIG. 8 is a view illustrating an index table.

FIG. 9 is a view illustrating a data structure of each pixel.

FIG. 10 is a flowchart illustrating a purchasing process.

FIG. 11 is a view illustrating an example of a purchasing UI image.

FIG. 12 is a flowchart illustrating a delivery accounting process.

FIG. 13 is a view illustrating an example of an agency store database SDB.

FIG. 14 is a flowchart illustrating a consumable goods supplementing process.

FIG. 15 is a view illustrating a software configuration for an index stable creating process.

FIG. 16 is a flowchart illustrating an index table creating process.

FIG. 17 is a view illustrating a software configuration for a calibration process.

FIG. 18 is a flowchart illustrating a calibration process.

FIG. 19 is a view illustrating an example of a color chart.

FIG. 20 is a graph illustrating deviation in a spectral reflectance.

FIG. 21 is a view schematically illustrating a calculation of a Jacobian matrix J.

FIG. 22 is a view schematically illustrating a printing method of a printer.

FIG. 23 is a view illustrating a database for a spectral reflectance.

FIG. 24A is a view illustrating a spectral Neugebauer model.

FIG. 24B is a view illustrating a Murray-Davies model.

FIG. 25A is a view illustrating a cellular Yule-Nielsen Spectral Neugebauer Model.

FIG. 25B is a view illustrating a relationship between ink area coverage and an ink amount in a cell division model.

FIG. 25C is a view illustrating a calculation method of a prediction of spectral reflectance.

FIG. 26 is a view illustrating a configuration of a designation module according to a modified example.

FIG. 27 is a flowchart illustrating a designation process according to a modified example.

FIG. 28 is a view illustrating a software configuration of a computer according to a modified example.

FIG. 29 is a flowchart illustrating a designation process according to a modified example.

FIG. 30 is a view illustrating an example of a region designating image according to a modified example.

FIG. 31 is a view illustrating a software configuration of an application according to a modified example.

FIG. 32 is a flowchart illustrating a sorting-out process according to a modified example.

FIG. 33 is a view illustrating an example of a condition designating image according to a modified example.

FIG. 34 is a view illustrating an example of an index table according to a modified example.

FIG. 35 is a view illustrating a display example of a patch according to a modified example.

FIG. 36 is a view illustrating a software configuration of a paint dealing system according to a modified example.

FIG. 37 is a view illustrating a software configuration of a paint dealing system according to a modified example.

FIG. 38 is a view illustrating a software configuration of a paint dealing system according to a modified example.

### DESCRIPTION OF EXEMPLARY EMBODIMENTS

In the following, an embodiment according to the invention will be described in accordance with the procedure as follows:

A. Overall Configuration:

B. Sample Sheet Printing Process:

C. Purchasing Process:

D. Delivery Accounting Process:

E. Consumable Goods Supplementing Process:

F. Ink Amount Set:

F1. Index Table Creating Process:

F2. Calibration Process:

G. Spectral Printing Model:

H. Modified Example:

H1. First Modified Example:

H2. Second Modified Example:

H3. Third Modified Example:

H4. Fourth Modified Example:

H5. Fifth Modified Example:

H6. Sixth Modified Example:

H7. Seventh Modified Example:

I. Conclusion

### A. OVERALL CONFIGURATION

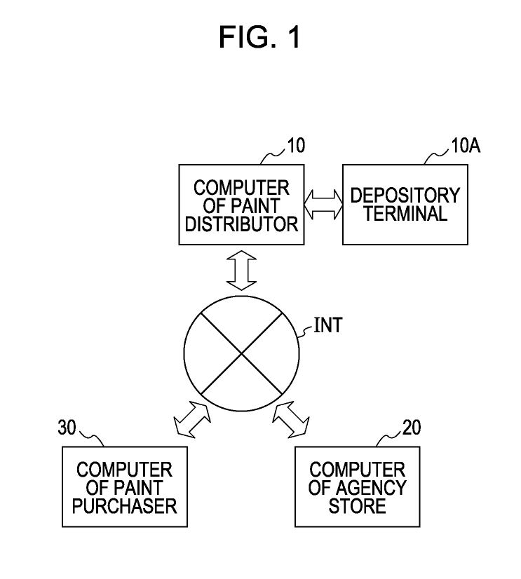

FIG. 1 schematically shows computers constituting a paint dealing system and a sales accounting system of the invention, and a network. In the drawing, the invention is configured to include at least a computer 10 of a paint distributor, a computer 20 of an agency store, and a computer 30 of a paint purchaser, and all of which are connected to each other capable of communicating via the Internet INT. In this embodiment, the respective computers 10, 20, and 30 are illustrated to be connected to each other via the Internet INT, but all or a part of the communication lines may be configured by interposing another communication medium (communication protocol) such as a wire/wireless telephone line. In addition, the computer 10 of the paint distributor may be connected to a depository terminal 10A via the Internet INT or a LAN (not shown).

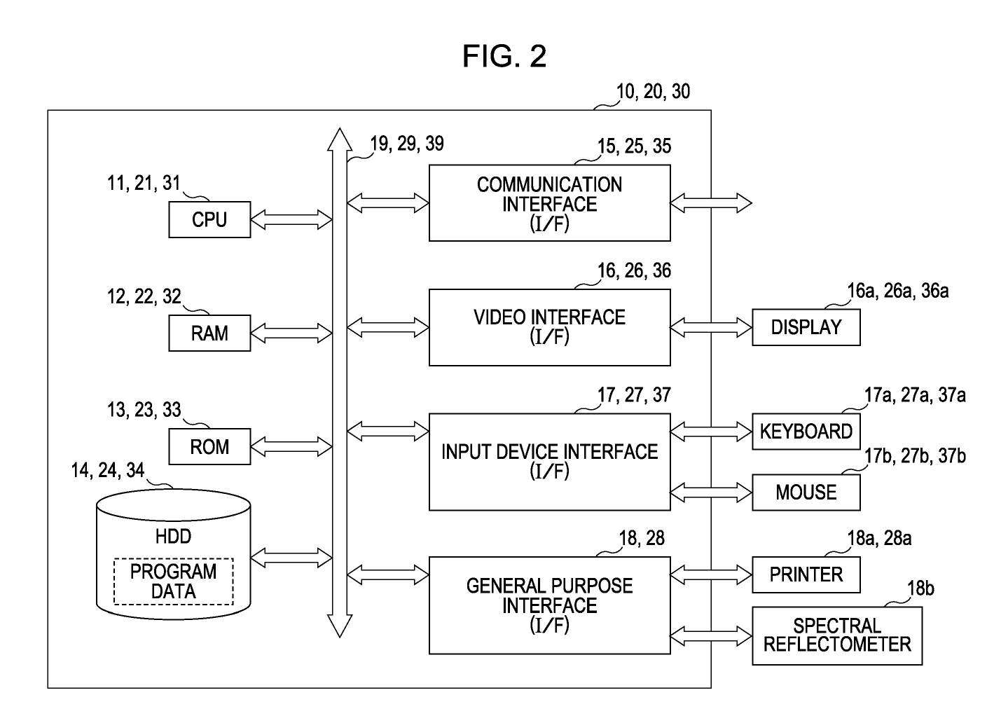

FIG. 2 shows an example of a hardware configuration of the computers 10, 20, and 30. The computers 10, 20, and 30 in this embodiment include the similar hardware configuration. The computers 10, 20, and 30 is configured to include CPUs 11, 21, and 31, RAMs 12, 22, and 32, ROMs 13, 23, and 33, hard disk drives (HDD) 14, 24, and 34, communication interfaces (I/F) 15, 25, and 35, video interfaces (I/F) 16, 26, and 36, input device interfaces (I/F) 17, 27, and 37, general purpose interfaces (I/F) 18 and 28, and buses 19, 29, and 39. The CPUs 11, 21, and 31 develop program data stored in the ROMs 13, 23, and 33 and the HDDs 14, 24, and 34 to the RAMs 12, 22, and 32, and perform a calculation for performing processes and functions, which will be described later. The communication I/Fs 15, 25, and 35 act as an intermediaries for connecting the computers 10, 20, and 30 to the Internet INT. The video I/Fs 16, 26, and 36 perform a process for outputting a video to external displays 16a, 26a, and 36a. The input device I/Fs 17, 27, and 37 accept operations on external keyboards 17a, 27a, and 37a or external mouses 17b, 27b, and 37b, and transmit signals based on the operations to the CPUs 11, 21, and 31.

The general purpose I/Fs 18 and 28 provided at the computers 10 and 20 of the paint distributor and the agency store serve to provide interfaces for connecting external printers (print apparatus) 18a and 28a to the computer 20. The general purpose I/F 18 provided at the computer 10 of the paint distributor serves to provide the interface for controlling a spectral reflectometer 18b. Further, in this embodiment, the printer 18a connected to the computer 10 of the paint distributor and the printer 28a connected to the computer 20 of the agency store are the same model. It is assumed that the printer 18a is a standard machine. The above-mentioned constituent elements 11 to 18, 21 to 28, and 31 to 37 are connected to each other and are capable of communicating via the buses 19, 29, and 39, and by communicating to each other the constituent elements 11 to 18, 21 to 28, and 31 to 37 can be configured to perform processes in cooperation with each other. Further, in the computer 30, the printer may not be connected thereto. The agency store is an agency store which acts as an intermediary in the paint sale, and the computer 20 is provided at the agency store. Further, the computer 20 of the agency store and the computer 30 of the paint purchaser are each illustrated as a single computer, but there may be a large number of agency stores and paint purchasers and the plural computers 20 and 30 are provided in proportion thereto.

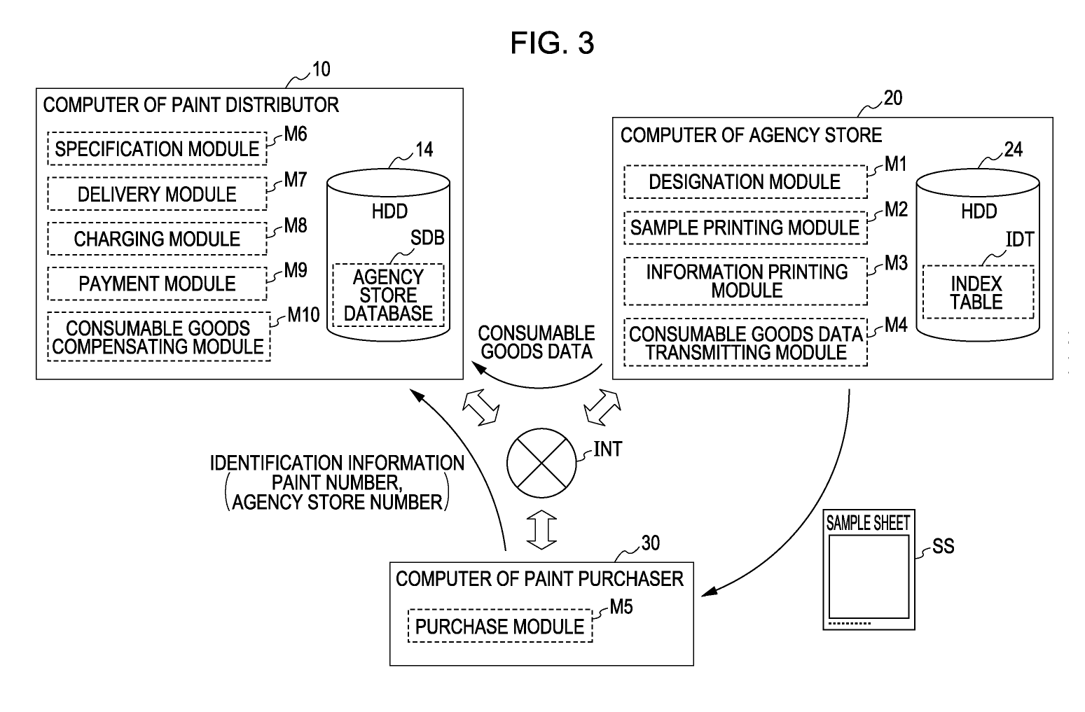

FIG. 3 shows principal data and software configurations provided in the computers 10, 20, and 30. First, in the computer 20 of the agency store, a designation module M1, a sample printing module M2, an information printing module M3, and a consumable goods data transmitting module M4 are performed. A purchase module M5 is performed in the computer 30 of the paint purchaser. In the computer 10 of the paint distributor, a specification module M6, a delivery module M7, a charging module M8, a payment module M9, and a consumable goods supplementing module M10 are performed. The designation module M1 accepts the designation of the paint carried by the paint purchaser who visits the agency store in which the computer 20 is provided. In the agency store, for example, the samples (a wood, a plastic, a stone, and the like coated with the respective paints) of the paints are provided, and the paint purchaser may designate the paint sample which has a favorite color or a favorite texture. Each of the samples is attached with a unique paint number (identification information of the invention) of the corresponding paint, so that designation of the paint is accepted by inputting the paint number to the computer 20.

The sample printing module M2 acquires the paint number of the designated paint, and prints the sample of the paint according to an ink amount set corresponding to the paint number. The printer 28a according to this embodiment is an ink jet printer which can eject an ink as a coloring material by any combination of the ink colors C (cyan), M (magenta), Y (yellow), K (black), lc (light cyan), and lm (light magenta). By designating the combination (ink amount set φ) of the CMYKlclm ink amounts, the printer 28a realizes a dot recording rate of each ink according to the ink amount on a recoding medium (a glossy paper in this embodiment). As a result, it is possible to realize a color (a spectral reflectance) approximating to any paint on the glossy paper. In the HDD 24, an index table IDT is stored as a database according to the invention, in which a correspondence relationship between the paint number and the ink amount set is defined in the index table IDT.

The ink amount set defined in the index table IDT is configured to eliminate deviation in the characteristics of the ink ejection which mainly depends on an individual printer 28a and is configured in consideration of a fine adjustment (a calibration process to be described later) for matching with the output characteristics of an ideal standard machine. The information printing module M3 performs a process of printing the paint number and a unique agency store number (identification information of the invention) of the agency store using characters in addition to the sample of the paint described above. The consumable goods data transmitting module M4 acquires the glossy paper and the ink amount of each of the CMYKlclm which are the consumable goods exhausted by printing the sample, and transmits the consumable goods data which specifies the kinds and the amount of the exhausted consumable goods to the computer 10 of the paint distributor via the Internet INT.

The purchase module M5 performed in the computer 30 of the paint purchaser performs a predetermined UI display to accept inputs such as the paint number which the paint purchaser wants to buy and the agency store number. The specification module M6 performed in the computer 10 of the paint distributor acquires the paint number and the agency store number which are transmitted by the purchase module M5, and specifies the paint as the purchase object on the basis of the paint number. As a result, the delivery module M7 can specify the paint which is delivered to the paint purchaser, and perform a process of delivery. When the purchase content is specified by the specification module M6, the charging module M8 calculates a price corresponding to the purchase content, and performs a process of charging the price to the paint purchaser. The payment module M9 acquires the purchase content and the agency store number, and specifies the agency store where the sample of the purchased paint is printed on the basis of the agency store number. Then, a process of paying the price for printing the sample is performed on the specified agency store. The consumable goods supplementing module M10 receives the consumable goods data which is transmitted from the consumable goods data transmitting module M4, and performs a process of supplementing the consumable goods on the agency store on the basis of the consumable goods data.

### B. SAMPLE SHEET PRINTING PROCESS

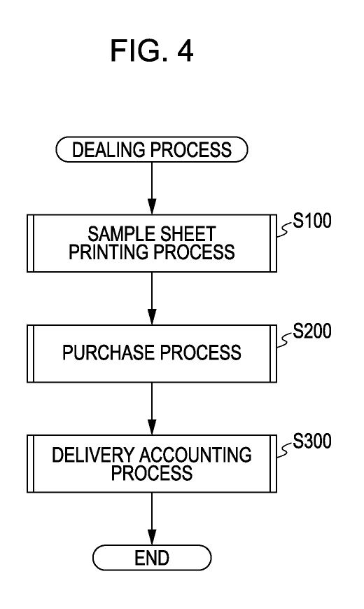

FIG. 4 shows a schematic flow of a dealing process which is performed by a paint dealing system according to the invention. In this embodiment, a sample sheet printing process (step S100) is first performed in the computer 20 of the agency store. Next, a purchasing process (step S200) is performed in the computer 30 of the paint purchaser. Furthermore, a delivery accounting process (step S300) is performed in the computer 10 of the paint distributor. Here, the sample sheet printing process (step S100) will be described first.

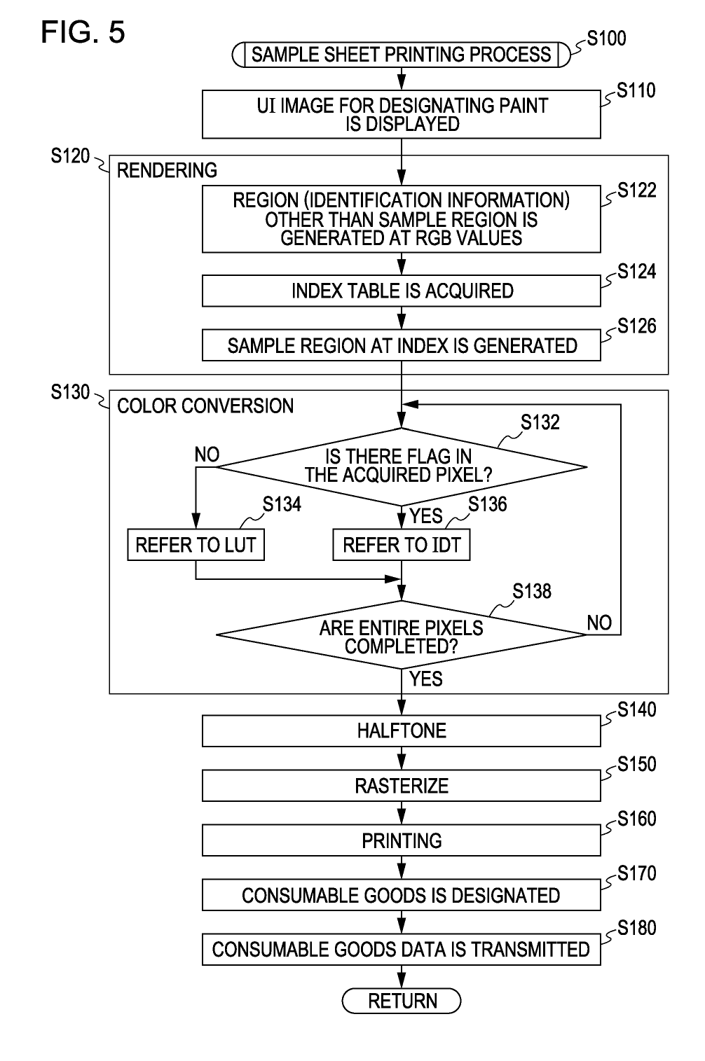

FIG. 5 shows a flow of the sample sheet printing process. The sample sheet printing process is performed in the computer 20 of the agency store, and specifically is performed by the designation module M1, the sample printing module M2, the information printing module M3, and the consumable goods data transmitting module M4. These modules M1 to M4 come to be in an executable state by installing the installation data, which is previously transmitted from the paint distributor via the Internet INT, on the computer 20. When the installation data is installed, an initial setting is performed between the computer 10 of the paint distributor and the computer 20 of the agency store via the Internet INT. In the initial setting, the unique agency store number of the agency store, the name of the agency store, and a payment method for the agency store are registered in advance. The information on the agency store is registered on an agency store database SDB which is stored in the HDD 14 of the computer 10 of the paint distributor. Further, the respective modules M1 to M4 are not necessarily installed in the computer 20. For example, the computer 10 of the paint distributor performs the process of the respective modules M1 to M4, and a general-purpose browser or the like executed on the computer 20 may be provided to interface with the paint purchaser. In step S110, the designation module M1 displays a predetermined UI image on the display 26a, and accept designation of the paint number from the paint purchaser who visits the agency store.

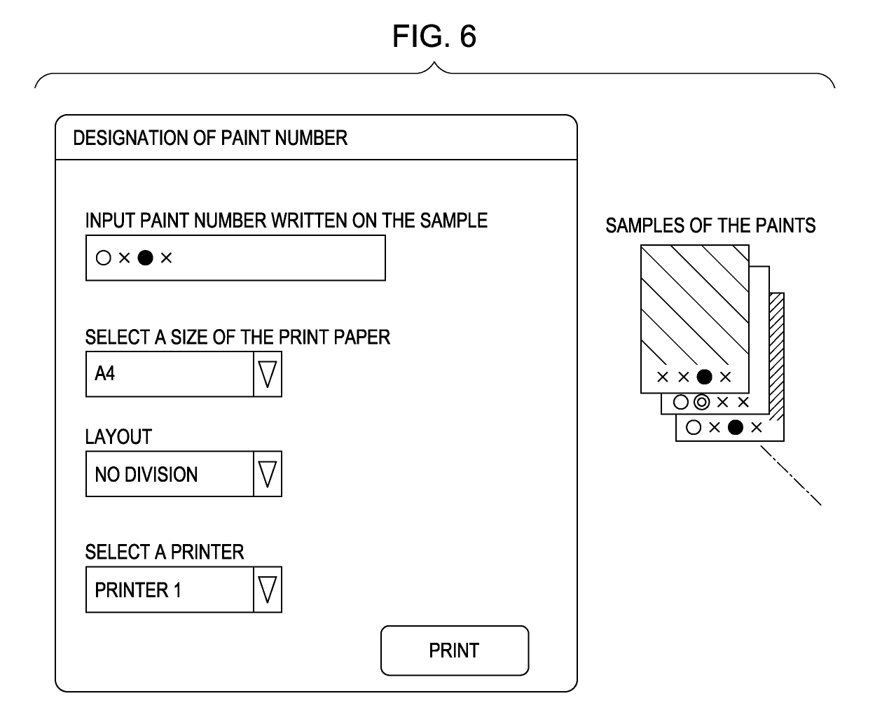

FIG. 6 shows an example of the UI image. As shown in the drawing, a text box is provided in the UI image, and thus it is possible to input the paint number in the text box using the keyboard 27a. As described above, the paint samples are disposed in the agency store, and the paint purchaser can identify the paint number which is written on each sample. The paint purchaser selects a favorite one among the samples, and inputs the paint number written on the sample to the text box. In addition, in the UI image, pull-down menus are provided to designate a print paper size, a layout, and the printer 28a, so that these can be designated. For example, it is possible to designate two kinds of paint samples to be arranged on the A3 paper. Further, this embodiment will be described such that one sample is designated to be arranged on the A4 paper. A print button is provided on the UI image, and the designation module M1 accepts the click of the print button. When the designation module M1 accepts the click of the print button, the sample printing module M2 and the information printing module M3 start the rendering of the print data PD and print the sample sheet SS in step S120.

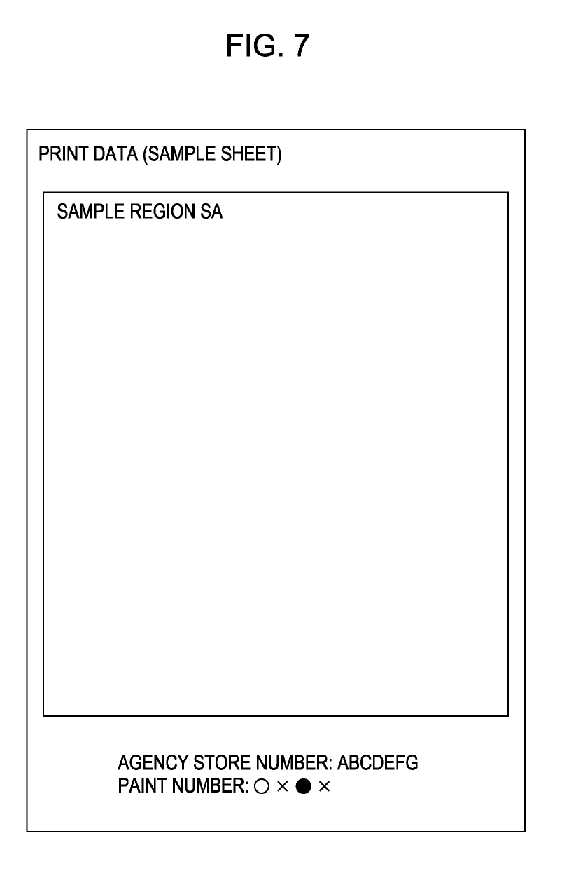

FIG. 7 schematically shows the print data PD (sample sheet SS). The print data PD is image data representing an image corresponding to the sample sheet SS. The print data PD is configured of a large number of pixels which are arranged in a dot matrix. Each pixel includes 4 bytes (8 bits×4) of information. In the center portion of the print data PD, a sample region SA is provided in a rectangular shape for printing the paint sample having the designated paint number. On the lower side of the sample region, character strings are generated to represent the designated paint number and the agency store number. In step S122, the information printing module M3 first generates the image data of a frame-shaped region on the outside of the sample region SA on the basis of the designation of the print paper size and the layout. The pixels constituting the frame-shaped region on the outside of the sample region SA store the RGB values using 3 bytes out of 4 bytes. Specifically, 1 byte is used for storing 8 bits of the R value, 1 byte is used for storing 8 bits of the G value, 1 byte is used for storing 8 bits of the B value, and the remaining 1 byte is not used.

For example, when the frame-shaped region on the outside of the sample region SA is displayed in a white color, the print data PD is generated such that the pixels of the frame-shaped region have information of (R, G, B)=(255, 255, 255). When the character strings representing the paint number and the agency store number are displayed with the black color, the print data PD is generated such that the pixels corresponding to the character strings have information of (R, G, B)=(0, 0, 0). Next, the sample printing module M2 performs a process of generating the pixels belonging to the sample region SA. Here, the sample printing module M2 obtains the index corresponding to the designated paint number by referring to the index table IDT stored in the HDD 24 (step S124). Further, the index table IDT is prepared for each printer 28a, and the index table IDT is used which corresponds to the designated printer in the UI image described above.

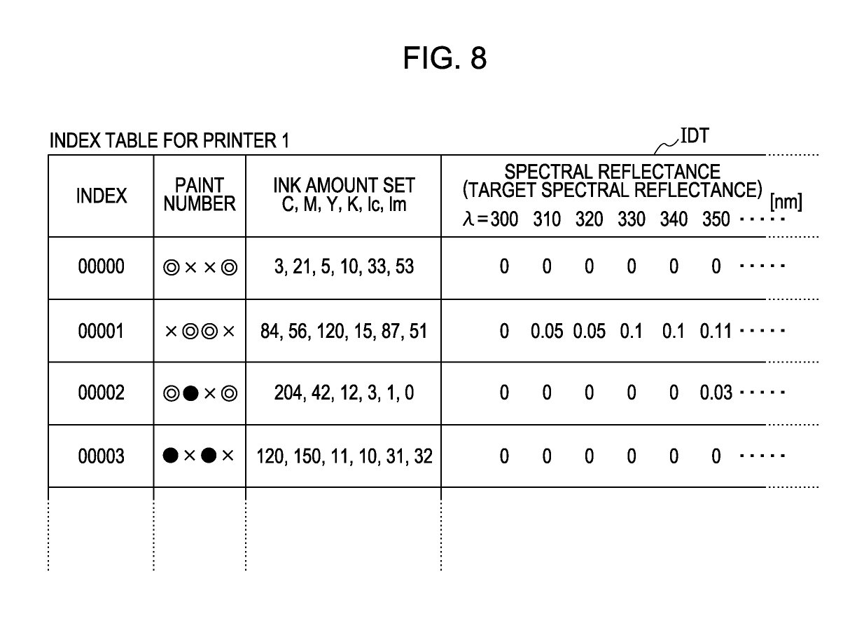

FIG. 8 shows an example of the index table IDT. In the index table IDT illustrated in the drawing, the correspondence relationship among an apparatus number of the printer 28a, the paint number, the index, and the ink amount set which means the combination of the CMYKlclm ink amounts, is defined. In addition, each paint number is associated with a target spectral reflectance Rₜ(λ) Further, the paint number and the index are both unique. In this embodiment, the paint number and the index are provided independently from each other, but the index can also be used as the paint number. The ink amount set defined in the index table IDT reproduces the same spectral reflectance characteristics as those of the paint associated with the paint number, and the details of which will be described in an index table creating process and a calibration process. In step S124, first, with reference to the index table IDT, the index corresponding to the designated paint number is acquired. Then, the designation module M1 stores the index in each pixel belonging to the sample region SA (step S126). The region storing the index in each pixel uses 3 bytes storing the RGB values in pixels other than the sample region SA, a flag, which represents the storing of the index, is stored in the remaining 1 byte. In this embodiment, a single paint number is designated, and the sample region SA is filled with the same pixels storing the index corresponding to the single paint number.

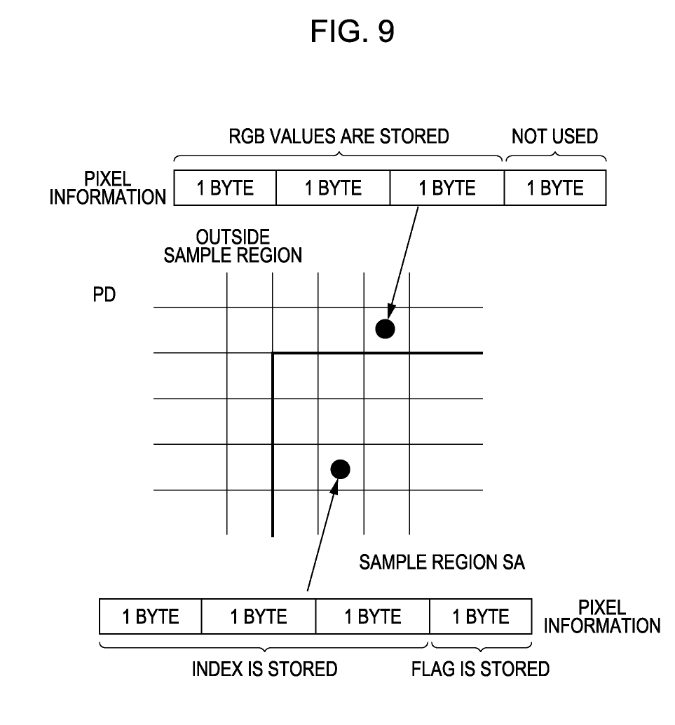

FIG. 9 schematically shows the data structure of each pixel. As shown in the drawing, in the pixels other than the sample region SA, the RGB values are stored using 3 bytes. On the other hand, in the pixels in the sample region SA, the index is stored using 3 bytes and the flag is stored using the remaining 1 byte. As described above, when the rendering of the print data PD is completed, the sample printing module M2 performs a color conversion process on the print data PD in step S130. First, in step S132, the sample printing module M2 acquires the pixel of the print data PD, and determines whether or not the above-mentioned flag is appended to the pixel. Then, when the flag is not appended, the sample printing module M2 refers to a color conversion table LUT stored in the HDD 24 to convert the print data PD into the ink amount set of the CMYKlclm corresponding to the RGB values stored in the pixel (step S134). Specifically, an interpolation calculation is carried out using information on a grid point defined in the color conversion table LUT to acquire the ink amount set corresponding to the RGB values. Further, the color conversion table LUT is a look-up table which is referred to when the printer 28a prints a general print material. For example, the look-up table is created by a technique disclosed in JP-A-2007-336198. According to the technique, it is possible to create the color conversion table LUT which is a good combination of gradation of a reproduced color, graininess, light-source independency of a reproduced color, gamut, and ink duty.

On the other hand, when the flag is appended, the sample printing module M2 refers to the index table IDT to convert the print data PD into the ink amount set corresponding to the index stored in the pixel (step S136). In step S138, it is determined whether or not the color conversion is completed on all of the pixels. When the color conversion is not completed, the process returns to step S132, and the next pixel is subjected to the color conversion. By repeating the above-mentioned processes, all the pixels are finally converted into the print data PD which has the ink amount set of the CMYKlclm. In step S140, the sample printing module M2 performs a halftone process on the color-converted print data PD.

Since all the pixels of the print data PD are converted into the pixel data of the ink amount set by the color conversion in step S130, the halftone process can be uniformly carried out. For example, with a dither method or a random dither method, the multi-gradation ink amount set is made to be low gradation data (gradation where the ejection of a single size dot or a multiple size dot is available). Furthermore, a rasterizing process is performed in step S150 to assign the print data PD subjected to the halftone process to each path or each nozzle of the print head provided at the printer 28a. Therefore, the print data PD available to the printer 28a is created and the printer 28a performs a printing on the basis of the print data PD in step S160. Accordingly, the sample sheet SS can be printed on the glossy paper which is set on the printer 28a in advance.

The sample region SA of the sample sheet SS is printed by forming the dots on the basis of the ink amount set which corresponds to the paint number designated in the index table IDT, so that the same spectral reflectance characteristics as the paint corresponding to the paint number can be implemented. Therefore, by viewing the sample region SA, the paint purchaser can confirm a state where the paint is actually coated. The size of the sample sheet SS can be set to a size of the print paper which the printer 28a can print, and the state of the paint can be confirmed by the sample region SA having an area lager than the above-mentioned sample. In addition, since the unique agency store number of the agency store which prints the sample sheet SS and the unique paint number of the paint forming the sample region SA are printed in the sample region SA, the paint purchaser can read these identification information.

As described above, when the sample sheet SS is printed, the consumable goods data transmitting module M4 specifies the amount of the consumable goods exhausted in each printing of the sample sheet SS in step S170. The amount of the consumable goods in the printer 28a can be specified on the basis of the print data PD output by the printer 28a. Since the glossy paper on which the sample sheet SS is printed is exhausted by one sheet for each output of the print data PD, it is possible to specify that the glossy paper of the designated print paper size (A4) is exhausted by one sheet. The CMYKlclm ink amounts exhausted in each printing of the sample sheet SS can be obtained by taking the statistics of the number of times each ink represented by the print data PD after the halftone process is ejected. Since the unit amount of ejected ink of one shot can be specified by the specification for the print head of the printer 28a, the consumed ink amount can be specified by multiplying the number of times each ink is ejected and the unit ejecting ink amount together.

In addition, a sensor is provided to detect the amount of ink stored in an ink tank for storing the ink, and the consumed ink amount may be specified on the basis of a measurement value of the sensor. The consumable goods data transmitting module M4 transmits the consumable goods data specified as described above to the computer 10 of the paint distributor (step S180). The above-mentioned agency store number is stored in the consumable goods data. The index table IDT used in this embodiment is not necessarily stored in the HDD 24 of the computer 20 of the agency store, but in the HDD 14 of the computer 10 of the paint distributor, and may be referred via the Internet INT as needed. By managing the index table IDT in the HDD 14 of the computer 10 of the paint distributor, it is possible to respond to the addition of a new paint product flexibly and quickly.

### C. PURCHASING PROCESS

The paint purchaser takes the sample sheet SS printed by the above-mentioned sample sheet printing process to his or her own house and attaches or places the sample sheet SS, so that the result when the paint is coated may be confirmed. At this time, the color of the sample region SA may be confirmed under the light source which irradiates the place to be actually coated by the paint. In most cases, the paint purchaser selects plural kinds of the paints as purchasing candidates, and prints the sample sheets SS of the plural paints. The paint purchaser selects a favorite sample sheet SS, and performs a purchasing process for purchasing the paint, with which the sample is printed on the sample sheet SS, by the computer 30.

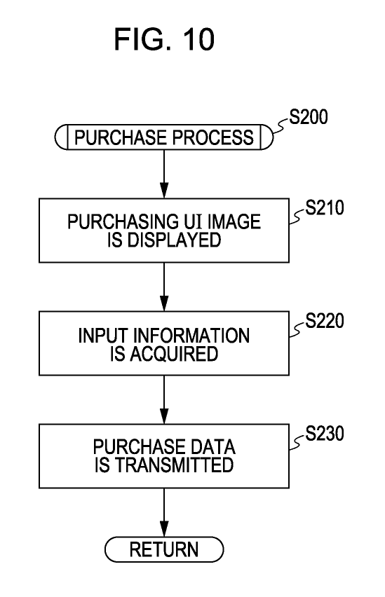

FIG. 10 shows a flow of the purchasing process. The purchasing process is performed by the purchase module M5. The purchase module M5 comes to be in an executable state by installing the installation data previously provided from the paint distributor in the computer 30. Further, the purchase module M5 is not necessarily installed in the computer 30. For example, the computer 10 of the paint distributor performs the process of the purchase module M5, and a general-purpose browser or the like executed on the computer 30 may be provided to interface with the paint purchaser. In step S210, the purchase module M5 displays the purchasing UI image on the display 36a to accept the operations of the paint purchaser.

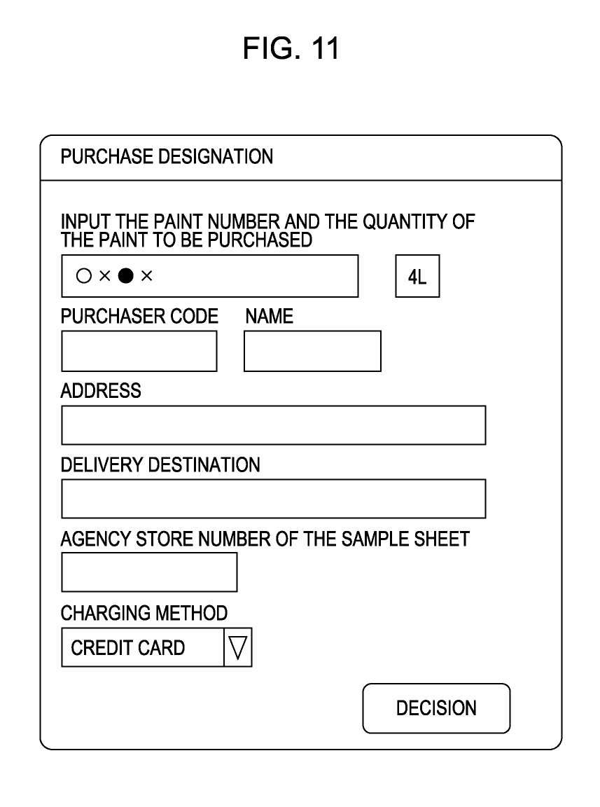

FIG. 11 shows an example of the purchasing UI image. In the UI image, there are provided text boxes which receive the private information (purchaser code, name, address, delivery destination) of the paint purchaser, a text box which receives the paint number of the paint to be purchased, a text box which receives the agency store number, a text box which receives the quantities of the paints to be purchased, a text box which receives the charging method or the like, and a decision button. In step S220, the click of the decision button is detected, and at a point in time when the decision button is clicked, the text information input in each text box is acquired. Then, the purchase module M5 transmits the purchase data (for example, text data, XML data, etc.) including the text information to the computer 10 of the paint distributor in step S230. Of course, the data may be subjected to encoding when being transmitted.

### D. DELIVERY ACCOUNTING PROCESS

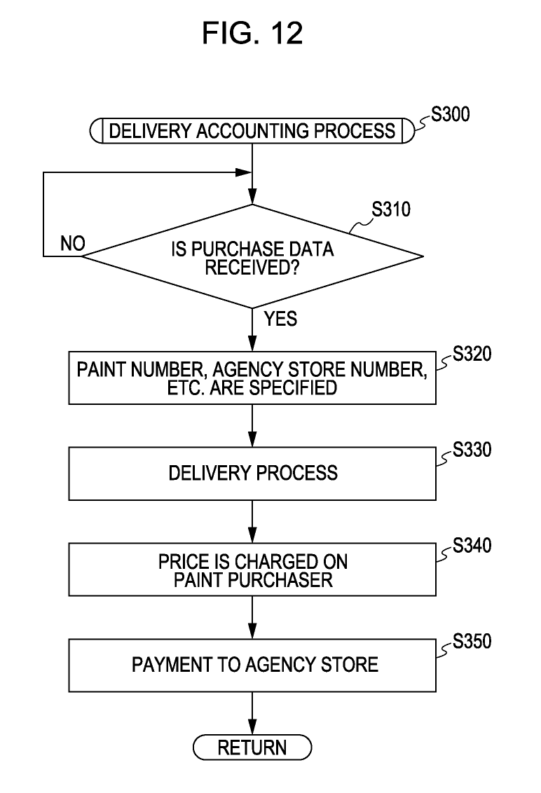

FIG. 12 shows a flow of a delivery accounting process. The delivery accounting process is performed on the computer 10 of the paint distributor, and more specifically, by the specification module M6, the delivery module M7, the charging module M8, and the payment module M9. These modules M6 to M9 are installed in the computer 10 in advance. In step S310, the specification module M6 receives the purchase data transmitted from the purchase module M5. The specification module M6 is on standby in a state capable of receiving the purchase data at any time, and starts the delivery accounting process at the point of receiving the purchase data. In step S320, the specification module M6 specifies the paint number, the agency store number, the purchase quantity, the private information of the paint purchaser, and the charging method.

In step S330, the delivery module M7 performs the delivery process on the basis of the information specified in step S320. The computer 10 of the paint distributor is connected to the depository terminal 10A disposed in the paint depository via, for example, the LAN or the Internet INT. The computer 10 informs the depository terminal 10A of the paint delivered by the delivery module M7, the quantity thereof, and the delivery destination. As a result, it is possible to deliver the paint desired by the paint purchaser in the desired quantity. It is matter of course that a delivering slip is created by the computer 10 and the slip may be transmitted to the depository without using the electronic technique.

In step S340, the charging module M8 calculates the price of the paint to be delivered on the basis of the paint number and the quantity specified in step S320. Specifically, a database is stored in the HDD 14 of the computer 10 of the paint distributor, in which the paint number and the unit price of the respective paints are stored. The unit price of the paint to be delivered is acquired with reference to the database, and is multiplied by the delivery quantity. Furthermore, by adding a delivery charge and a tax, the price to be charged in the purchase of the paint can be calculated. Next, a process of charging the price is performed according to the charging method specified in step S320. For example, the computer 10 of the paint distributor is connected to an electronic money settlement server (not shown) or a credit card settlement server (not shown), which is connected via the Internet INT, and the charging data on the price of the paint is transmitted. According to the process described above, it is possible to deliver the paint to the paint purchaser in the designated quantity, and can charge the price.

In the next step S350, a payment process is performed for acquiring the agency number specified in step S320 and paying (adding) a predetermined amount of money to the agency store associated with the agency store number. In this payment process, firstly, the amount of money to be paid to the agency store is calculated. Here, the payment amount corresponds to the cost of printing the sample sheet SS which is used for purchasing the paint by the paint purchaser. From the paint distributor viewpoint, it can be considered as a reward for making a contribution to the sale of the paint. Furthermore, if the agency store is considered as a retail store handling the paint, it can be also considered as the sale of the agency store. As a method of calculating the amount of money, various other methods can be employed. For example, the amount of money may be also calculated by multiplying the price charged to the paint purchaser in step S340 by a certain ratio. Further, the amount of money may be also calculated by multiplying the money obtained by deducting the cost of the paint from the price. In this way, the amount of money is calculated according to the price charged to the paint purchaser in step S340, so that the amount of money can be paid to the agency store according to the sale of the paint. When the amount of money to be paid to the agent store is calculated as described above, the process is carried out for paying the corresponding amount of money to the agency store which is associated to the agency store number specified in step S320. Here, the payment method registered regarding the agency store is acquired from the agency store database SDB.

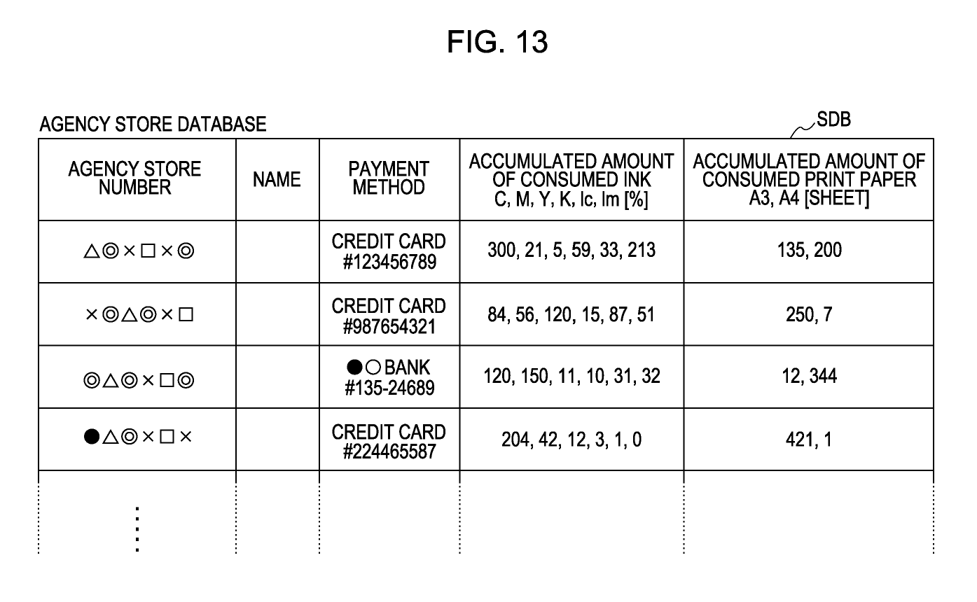

FIG. 13 shows an example of the agency store database SDB. As described above, the respective registration items of the agency store database SDB are registered in the initial setting when the respective modules M1 to M4 for printing the sample sheet SS are installed in the computer 20 of the agency store. In the agency store database SDB, the correspondence relationship among the agency store number, the name of the agency store, the payment method for the agency store, and the like are stored with respect to each agency store. For this reason, on the basis of the agency store number specified in step S320, the name of the agency store and the payment method can be specified, and the payment can be paid to the agency store which prints the sample sheet SS of the paint to be delivered. Similar to the charge to the paint purchaser described above, the computer of the agency store is connected to an electronic money settlement server (not shown) or a credit card settlement server (not shown), which is connected via the Internet INT, and the requirement for the payment to the agency store is transmitted. Accordingly, the cost of printing the sample sheet SS can be paid to the agency store which prints the sample sheet SS of the paint to be purchased.

### E. CONSUMABLE GOODS SUPPLEMENTING PROCESS

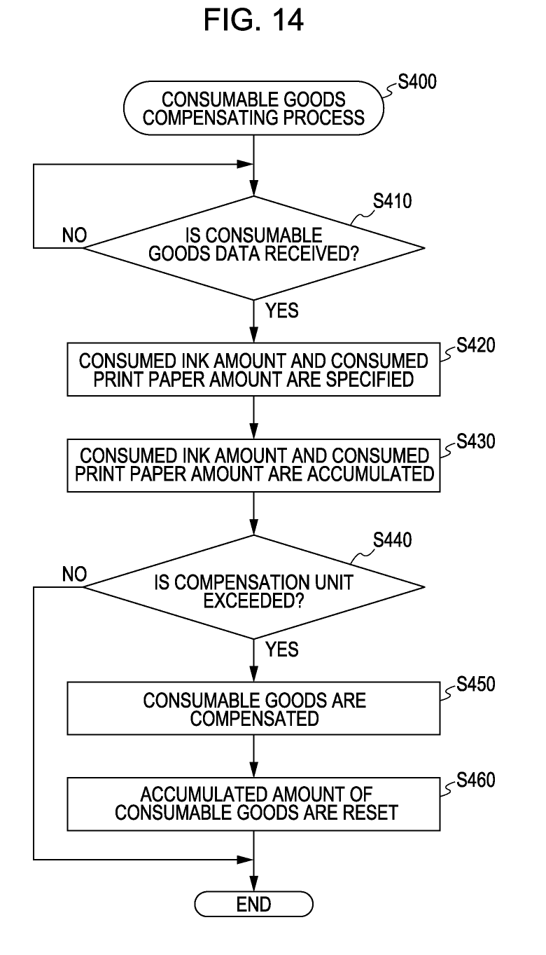

FIG. 14 shows a flow of the consumable goods supplementing process. The consumable goods supplementing process is performed by the consumable goods supplementing module M10 in the computer 10 of the paint distributor. Every time the sample sheet SS is printed in the sample sheet printing process described above, the consumable goods data on the consumable goods exhausted in each printing is transmitted to the computer 10 of the paint distributor (step S180). The consumable goods supplementing module M10 is on standby in a state capable of receiving the purchase data at any time, and starts the consumable goods supplementing process at a point of receiving the purchase data. In step S410, the consumable goods supplementing module M10 receives the consumable goods data. In step S420, the consumable goods supplementing module M10 specifies the agency store number, the consumed ink amount, and the size of the glossy paper from the consumable goods data. In this embodiment, since the consumable goods data is transmitted every time one sample sheet SS is printed, the amount of the consumed glossy paper (the amount of the consumed print paper) is always one sheet. In step S430, the consumable goods supplementing module M10 acquires the consumed ink amount and the amount of the consumed print paper which are registered on the above-mentioned agency store database SDB regarding the specified agency store. Then, the consumed ink amount and the amount of the consumed print paper which are obtained from the consumable goods data are added to the consumed ink amount and the amount of the consumed print paper which are registered on the agency store database SDB. That is, when the consumable goods data is received, the consumed ink amount and the amount of the consumed print paper are accumulated for every agency store.

In step S440, it is determined whether or not the consumed ink amount and the amount of the consumed print paper which are accumulated exceed a predetermined supplement unit. In this embodiment, the consumable goods are not supplemented every the consumable goods data is received. However, when the accumulated amounts of the ink and the print paper reach the predetermined supplement unit, the ink and the print paper are supplemented. For example, when the accumulated amount of the consumed ink reaches an amount corresponding to five ink cartridges (500%), the five ink cartridges are supplemented. In addition, when the accumulated amount of the consumed print papers (the glossy papers) reaches 500 sheets, the print papers are supplemented by 500 sheets. When it is determined that the accumulated amount of the consumed ink and the accumulated amount of the consumed printer papers exceed the predetermined supplement unit, the amount of the consumable goods corresponding to the supplement unit is supplemented (step S450). The computer 10 of the paint distributor is connected to the depository terminal 10A via, for example, the LAN or the Internet INT, and informs the depository terminal 10A of the consumable goods, which is supplemented by the consumable goods supplementing module M10, the amount thereof, and the address of the agency store to be supplemented.

As a result, the consumable goods exhausted in each printing of the sample sheet SS can be supplemented by each supplement unit. In step S460, regarding the supplemented consumable goods, the consumed ink amount and the amount of the consumed print paper which are registered on the agency store database SDB are reset to zero. Therefore, it is possible to prevent the consumable goods such as the print paper or the ink in the agency store from running short. Further, it is possible to prevent the agency store from having to the bear the burden of the consumable goods. In addition, since the consumable goods can be supplemented on the basis of the actually-used amount thereof, the consumable goods should be supplemented at a proper amount and with the proper frequency. In addition, the supplement frequency can be adjusted by changing the supplement unit. Further, in this embodiment, the consumable goods have been supplemented when the amount of the consumable goods occurs by the predetermined supplement unit. However, it may be configured such that the amount of money corresponding to the actual cost of the consumable goods is paid to the agency store in the payment process described above.

### F. INK AMOUNT SET

In the sample sheet printing process described above, the sample region SA is printed on the basis of the ink amount set defined in the index table IDT which is created in advance. Here, the index table creating process of creating the index table IDT and the calibration process of correcting the index table IDT which is once created will be sequentially described.

### F1. Index Table Creating Process

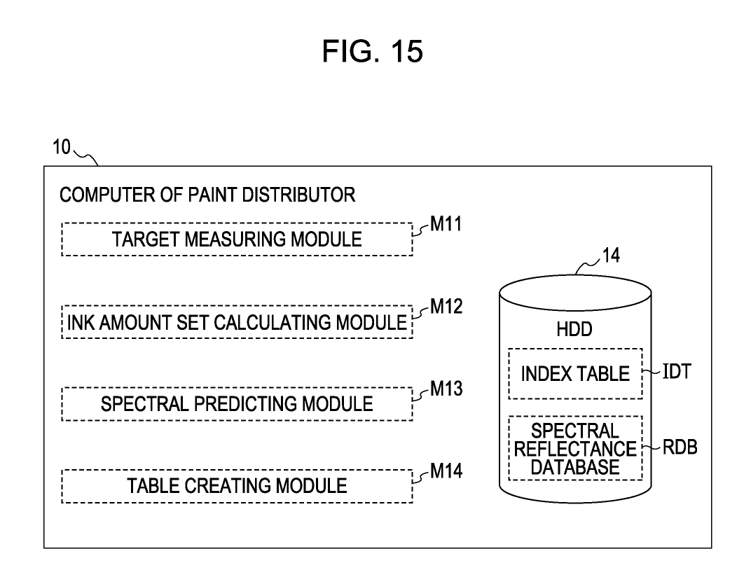

FIG. 15 shows a software configuration of the computer 10 which performs the index table creating process. The computer 10 performs a target measuring module M11, an ink amount set calculating module M12, a spectral predicting module M13, and a table creating module M14 as the software configuration for carrying out the index table creating process. The target measuring module M11 measures the target spectral reflectance Rₜ(λ) that is the spectral reflectance of the sample actually coated with each paint using the spectral reflectometer 18b. Further, the sample used here is the same thing as the sample (a wood, a plastic, a stone, and the like coated with the respective paints) described above. The ink amount set calculating module M12 calculates the ink amount set, with which the target spectral reflectance Rₜ(λ) is reproducible, using a spectral printing model to be described later. The table creating module M14 creates the index table IDT which defines the correspondence relationship between the ink amount set calculated by the ink amount set calculating module M12 and the paint number.

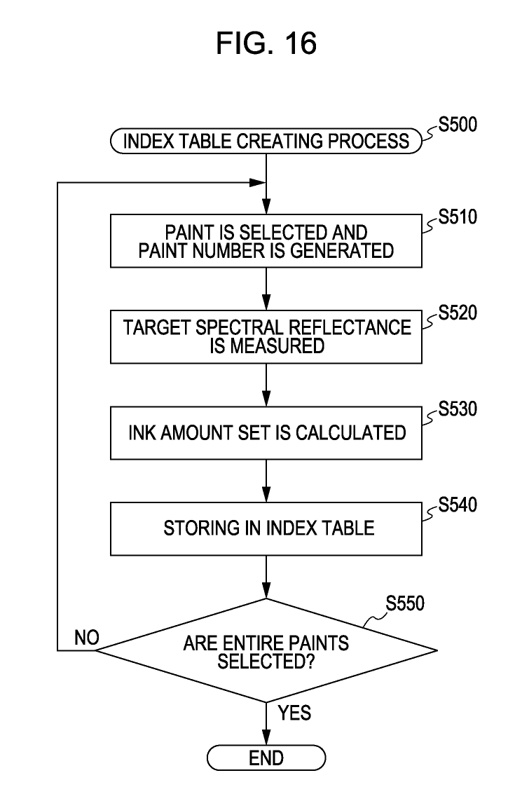

FIG. 16 shows a flow of the index table creating process. In step S510, the target measuring module M11 selects the paint of the object and generates the unique paint number of the paint. For example, the paint distributor handles several thousands of kinds of paints, and one of them is selected by the target measuring module M11. In step S520, the target spectral reflectance Rₜ(λ) of the selected paint sample is measured by the spectral reflectometer 18b. Further, the target spectral reflectance Rₜ(λ) is a vector configured of the spectral reflectance R(λ) in each wavelength section (for example, 10 nm partition). In step S530, the ink amount set calculating module M12 calculates an optimized solution for the ink amount set, with which the target spectral reflectance Rₜ is reproducible, using the spectral predicting module M13. Hereinafter, any ink amount set of the CMYKlclm inks is denoted by the vector φ={d_{C}, d_{M}, d_{Y}, d_{K}, d_{lc}, dₗₘ}. By receiving any ink amount set φ as an input, the spectral predicting module M13 predicts the spectral reflectance (hereinafter, denoted by the predicted spectral reflectance Rₛ(λ)) when the printer 18a performs a printing on the glossy paper according to the ink amount set φ. That is, the spectral predicting module M13 receives the ink amount set φ as an input and provides a function PM(φ) for calculating the predicted spectral reflectance Rₛ(λ) by Equation 1 below:

[Equation 1]

Rₛ(λ)=PM(φ) (1)

The ink amount set calculating module M12 calculates the difference D(λ) between the target spectral reflectance Rₜ(λ) and the predicted spectral reflectance Rₛ(λ) with respect to each wavelength λ, and multiplies a weighting function w(λ) imposed with a weight on every wavelength λ by the difference D(λ). A square root of a square mean of the value is calculated as an evaluation value E(φ). When the above calculations are expressed as an equation, it can be expressed as Equation 2 below:

$$\begin{matrix}[ Equation 2 ] & \\ E ( φ ) = \sqrt{\frac{\sum {\{ w ( λ ) D ( λ ) \}}^{2}}{N}} \\ D ( λ ) = {R}_{t} ( λ ) - {R}_{s} ( λ ) & ( 2 )\end{matrix}$$

In Equation 2 described above, N means the number of sections in the wavelength λ. In Equation 2, as the evaluation value E(φ) decreases, the difference between the target spectral reflectance Rₜ(λ) and the predicted spectral reflectance Rₛ(λ) can be reduced in each wavelength λ. That is, as the evaluation value E(φ) decreases, when the printer 18b performs the printing on the glossy paper according to the input ink amount set φ, the spectral reflectance R(λ) reproduced on the glossy paper can be approximated to the target spectral reflectance Rₜ(λ) obtained from the sample of the corresponding paint.

In addition, a reproduced color of the printer 18a according to the ink amount set φ and an absolute color represented by the sample of the corresponding paint are changed according to the change of the light source. However, by reducing the evaluation value E(φ), both colors can be relatively matched. Therefore, with the ink amount set φ through which the evaluation value E(φ) decreases, it can be seen that a print result can be obtained in which the paint is equally perceived as representing the color of the paint under any light source.

In this embodiment, the weighting function w(λ) uses Equation 3 below:

[Equation 3]

w(λ)=x(λ)+y(λ)+z(λ) (3)

In Equation 3 described above, the weighting function w(λ) is defined by adding color-matching functions x(λ), y(λ), and z(λ). Further, the range of the value of the weighting function w(λ) may be normalized by multiplying the entire right side of Equation 3 by a predetermined coefficient. The color-matching functions x(λ), y(λ), and z(λ) include spectrums according to the visual sensitivity of human eyes, and it can attach importance to the spectral reflectance R(λ) in a wavelength band in which the human eyes are sensitive. For example, w(λ) becomes zero in a near-ultraviolet band which is not perceptible by human eyes, and the difference D(λ) in this wavelength band does not contribute to the increase in the evaluation value E(φ).

That is, even though the difference between the target spectral reflectance Rₜ(λ) and the predicted spectral reflectance Rₛ(λ) in the entire visible wavelength band is not necessarily small, when the target spectral reflectance Rₜ(λ) and the predicted spectral reflectance Rₛ(λ) are approximated to each other in the wavelength band which is strongly perceptible by human eyes, the small evaluation value E(φ) can be obtained. In addition, the evaluation value E(φ) can be used as a standard of the approximation of the spectral reflectance R(λ) based on the perception of human eyes. The ink amount set calculating module M12 makes the spectral predicting module M13 calculate the predicted spectral reflectance Rₛ(λ) each time the ink amount set φ is sequentially shifted, so that the evaluation value E(φ) is calculated. Then, an optimized solution of the ink amount set φ is calculated to minimize the evaluation value E(φ). As a scheme of calculating the optimized solution, various optimization schemes may be used. For example, it is preferable that a nonlinear optimization scheme called a gradient technique is used.

As described above, when the ink amount set φ with which the target spectral reflectance Rₜ(λ) is reproducible in step S530, the table creating module M14 associates the paint number of the sample measured of the target spectral reflectance Rₜ(λ), the target spectral reflectance Rₜ(λ), and the calculated ink amount set φ with one another, and all of which are stored in the index table IDT (step S540). In step S550, it is determined whether or not all the paints have been selected. When all the paints have not been selected, the procedure returns to step S510, and the next paint is selected. In this way, the paint can be sequentially selected, and thus the ink amount set φ, with which the target spectral reflectance Rₜ(λ) is reproducible, is calculated for each paint to be able to create the index table IDT in which the correspondence relationship between the paint number of each paint and the ink amount set φ is stored. The finally created index table IDT is installed on the computer 20 of the agency store via the Internet INT.

Hereinbefore, the process of newly creating the index table IDT with respect to all the paints which are manufactured and sold by the paint distributor has been described. However, when paints which are manufactured and sold by the paint distributor are added, it can respond by newly adding the paint number, the ink amount set φ, and the index to the existing index table IDT. Of course, regarding paint which is sold out, the paint number, the ink amount set φ, and the index thereof may be removed from the index table IDT. Therefore, even when the lineup of the paint of the paint distributor is changed, it is possible to respond thereto flexibly.

As described above, the printer 18a which is the standard machine connected to the computer 10 of the paint distributor and the printer 28a connected to the computer 20 of the agency store are of the same model. When the printers perform printing at the same ink amount set φ, it would be ideal if the printing results could be equal to each other. On the assumption of the ideal, the printer 28a obtains the same reproduction of the spectral reflectance by the index table IDT created on the basis of the reproduction of the spectral reflectance of the printer 18a. However, it is impossible to completely remove individual errors or time degradation from the printer 28a, so that it is necessary to perform calibration processes to remove these errors and to correct the index table IDT.

### F2. Calibration Process

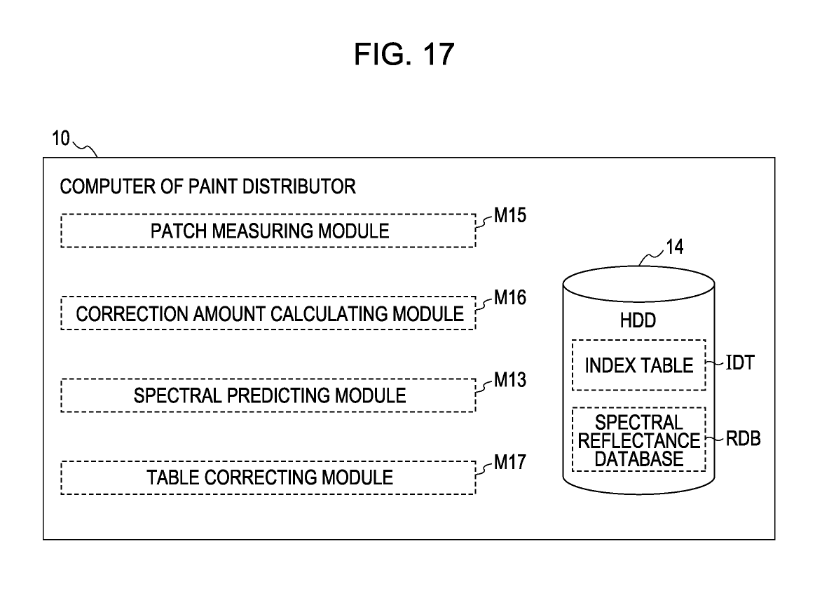

FIG. 17 shows a software configuration of the computer 10 which performs the calibration process. The computer 10 performs the spectral predicting module M13, a patch measuring module M15, a correction amount calculating module M16, and a table correcting module M17 as the software configuration for carrying out the calibration process. The spectral predicting module M13 carries out the same process as the index table creating process. The patch measuring module M15 measures the spectral reflectance (hereinafter, denoted by a correcting spectral reflectance R_{c}(λ)) of a correcting patch using the spectral reflectometer 18b with respect to each paint which is printed by the printer 28a connected to the computer 20 of the agency store. The correction amount calculating module M16 calculates a correction amount of the ink amount set φ on the basis of the target spectral reflectance Rₜ(λ) and the correcting spectral reflectance R_{c}(λ) of each paint. The table correcting module M17 reflects the correction amount calculated by the correction amount calculating module M16 to the index table IDT.

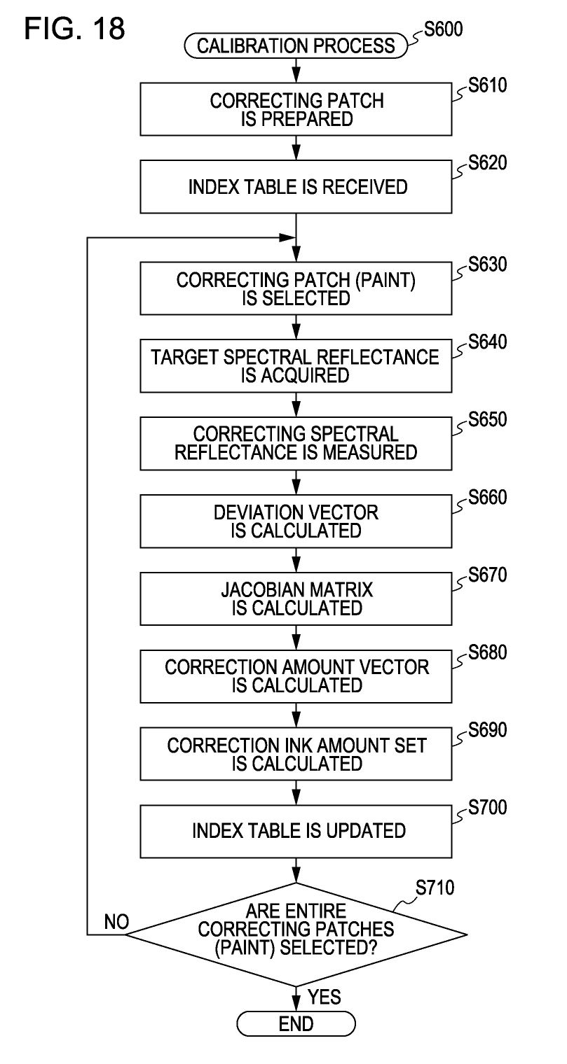

FIG. 18 shows a flow of the calibration process. In step S610, plural correcting patches are prepared which are printed by the printer 28a connected to the computer 20 of the agency store. Since the characteristics of ink ejection in the printer 28a are changed over time, a color chart is made to be periodically printed in the computer 20 of the agency store and the color chart is transmitted to the paint distributor.

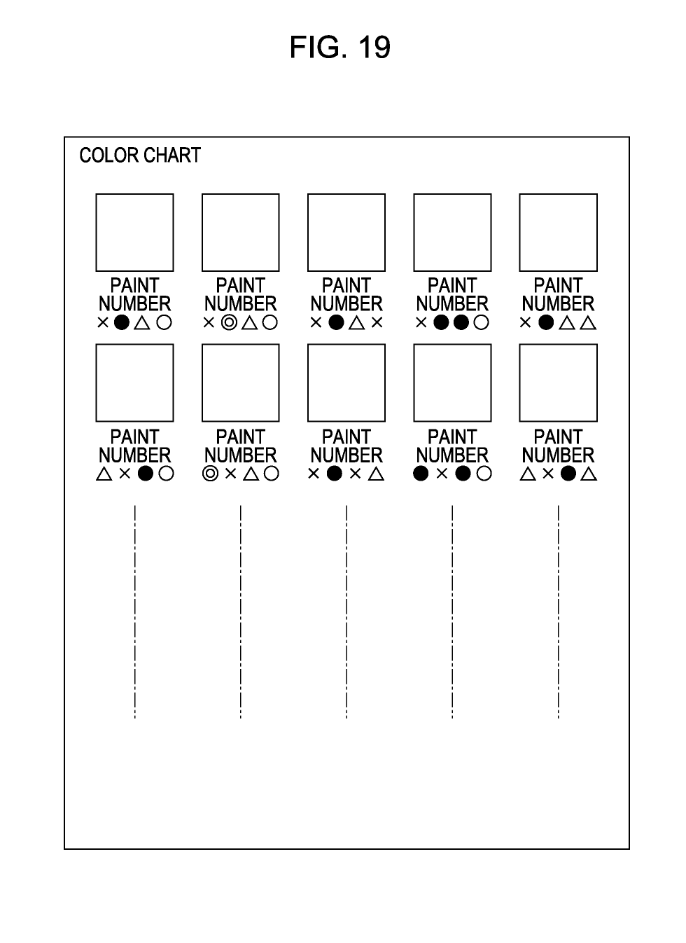

FIG. 19 shows an example of the color chart. In the color chart, a large number of correcting patches in a rectangular shape are arranged in a matrix shape. The correcting patches correspond to the paints respectively, and the paint numbers are printed on a position close to each correcting patch. When plural printers 28a are connected to the computer 20 of the agency store, an apparatus number is printed to specify any one of them. When the color chart is printed by the computer 20 of the agency store, the print data PD is generated by disposing the pixels, each of which stores the index and the flag corresponding to the paint number in the index table IDT stored in the HDD 24, on the positions corresponding to the correcting patches and the printing may be performed on the basis of the print data PD. As a result, similar to the sample region SA of the sample sheet SS, it is possible to print each correcting patch at the ink amount set φ defined in the index table IDT.

In step S620, the index table IDT used in the printing of the color chart is received from the computer 20 of the agency store. The ink amount set φ defined in the index table IDT becomes a correction object in the calibration process. In step S630, the patch measuring module M15 selects the correcting patch. In step S640, the input of the paint number of the selected correcting patch is accepted, and the target spectral reflectance Rₜ(λ) associated with the paint number in the index table IDT is acquired. In step S650, the correcting spectral reflectance R_{c}(λ) of the selected correcting patch is measured by the spectral reflectometer 18b. Here, it is ideal if the target spectral reflectance Rₜ(λ) and the correcting spectral reflectance R_{c}(λ) are matched with each other. However, due to the individual errors or the time degradation in the printer 28a, difference between the two occurs.

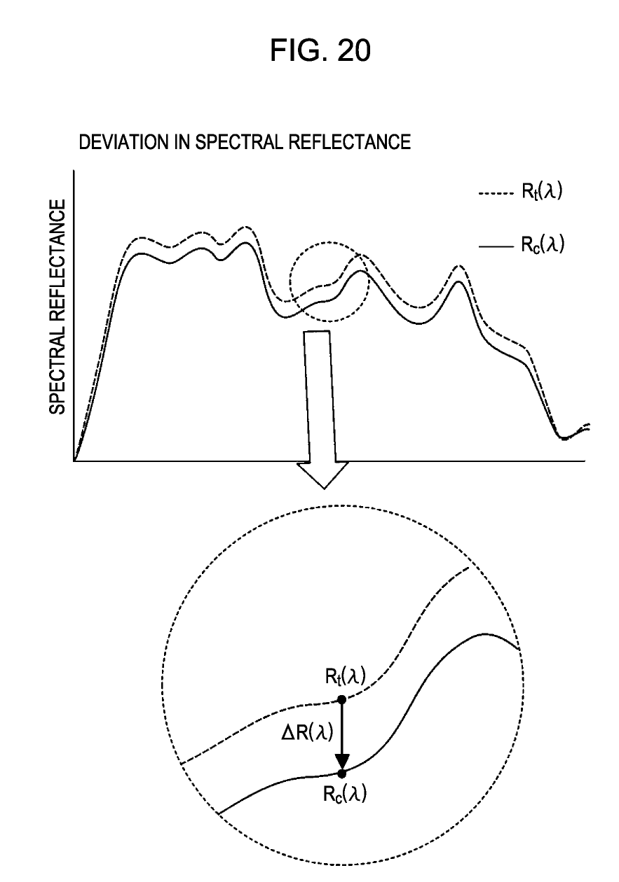

FIG. 20 shows the target spectral reflectance Rₜ(λ) and the correcting spectral reflectance R_{c}(λ) in contrast to each other with respect to a paint (paint number). As shown in the drawing, the correcting spectral reflectance R_{c}(λ) roughly traces the target spectral reflectance Rₜ(λ), but the correcting spectral reflectance R_{c}(λ) is shifted to the lower reflection as a whole. For example, when the ink amount of each ink which is ejected by the printer 28a increases over time, the correcting spectral reflectance R_{c}(λ) is shifted to the lower reflectance as a whole. In step S660, the correction amount calculating module M16 subtracts the target spectral reflectance Rₜ(λ) from the correcting spectral reflectance R_{c}(λ), and thus each deviation ΔR(λ) is calculated. Further, the deviation ΔR(λ) can be expressed by a deviation vector ΔR in Equation 4 consisting of the deviation ΔR(λ) in each wavelength section as follows:

[Equation 4]

ΔR=(ΔR₃₆₅, ΔR₃₇₅, ΔR₃₈₅ . . . ΔR₈₀₅, ΔR₈₁₅, ΔR₈₂₅) (4)

In Equation 4 described above, ΔRₐ shows an average deviation ΔR(λ) between the wavelength sections λ=(a−5)˜(a+5) [nm] (where, “a” is a value of 10 nm period in the visible wavelength band). The correction amount calculating module M16 acquires the ink amount set φ (the ink amount set φ defined in the index table IDT) when the selected correcting patch is printed in step S670, and calculates a Jacobian matrix J of the prediction of spectral reflectance Rₛ(λ) regarding a minute section in the vicinity of the ink amount set φ. When the Jacobian matrix J of the prediction of spectral reflectance Rₛ(λ) is calculated, the spectral predicting module M13 is used which can calculate the prediction of spectral reflectance Rₛ(λ) regarding any ink amount set φ. The Jacobian matrix J can be expressed by Equation 5 below:

$$\begin{matrix}[ Equation 5 ] & \\ J = [ \begin{matrix}\frac{\partial {R}_{s 365}}{\partial {d}_{C}} & \frac{\partial {R}_{s 365}}{\partial {d}_{M}} & \frac{\partial {R}_{s 365}}{\partial {d}_{Y}} & \frac{\partial {R}_{s 365}}{\partial {d}_{K}} & \frac{\partial {R}_{s 365}}{\partial {d}_{lc}} & \frac{\partial {R}_{s 365}}{\partial {d}_{l m}} \\ \frac{\partial {R}_{s 375}}{\partial {d}_{C}} & \frac{\partial {R}_{s 375}}{\partial {d}_{M}} & \frac{\partial {R}_{s 375}}{\partial {d}_{Y}} & \frac{\partial {R}_{s 375}}{\partial {d}_{K}} & \frac{\partial {R}_{s 375}}{\partial {d}_{lc}} & \frac{\partial {R}_{s 375}}{\partial {d}_{l m}} \\ ⋮ & ⋮ & ⋮ & ⋮ & ⋮ & ⋮ \\ \frac{\partial {R}_{s 815}}{\partial {d}_{C}} & \frac{\partial {R}_{s 815}}{\partial {d}_{M}} & \frac{\partial {R}_{s 815}}{\partial {d}_{Y}} & \frac{\partial {R}_{s 815}}{\partial {d}_{K}} & \frac{\partial {R}_{s 815}}{\partial {d}_{lc}} & \frac{\partial {R}_{s 815}}{\partial {d}_{l m}} \\ \frac{\partial {R}_{s 825}}{\partial {d}_{C}} & \frac{\partial {R}_{s 825}}{\partial {d}_{M}} & \frac{\partial {R}_{s 825}}{\partial {d}_{Y}} & \frac{\partial {R}_{s 825}}{\partial {d}_{K}} & \frac{\partial {R}_{s 825}}{\partial {d}_{lc}} & \frac{\partial {R}_{s 825}}{\partial {d}_{l m}}\end{matrix} ] & ( 5 )\end{matrix}$$

In Equation 5 described above, Rₛₐ shows an average prediction of spectral reflectance Rₛ(λ) between the wavelength sections λ=(a−5)˜(a+5) [nm]. The Jacobian matrix J is a matrix in a form of the number of the wavelength sections (rows)×the number of the inks (columns).

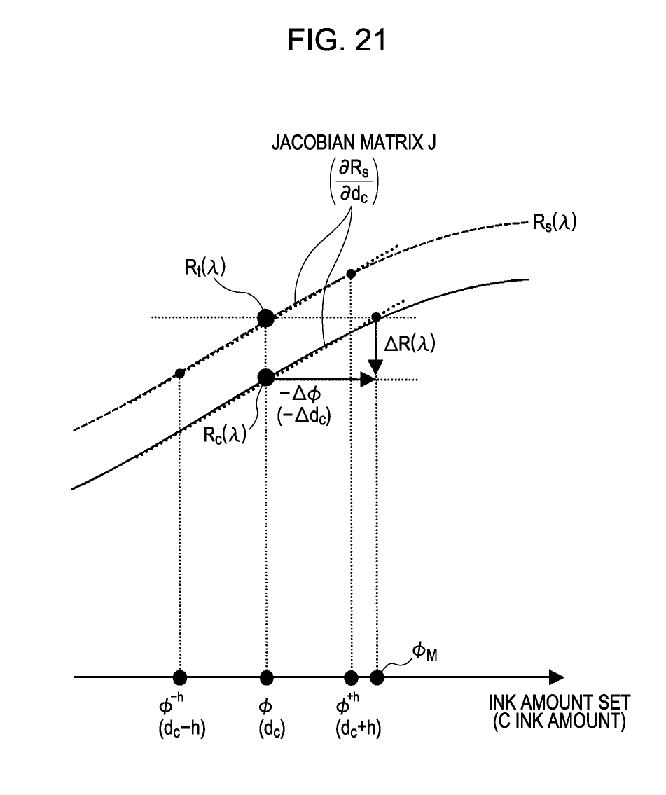

FIG. 21 shows the calculation of the Jacobian matrix J. First, paying attention to the C ink among the ink sets, the ink amounts (d_{C}+h) and (d_{C}−h) are calculated by adding or subtracting a minute amount h with respect to the ink amount d_{C} used when the correcting patch is printed. Then, while other inks remain as the ink amounts (d_{M}, d_{Y}, d_{K}, d_{lc}, dₗₘ) which are used when the correcting patch is printed, the ink amount set φ^{+h}(d_{C}+h, d_{Y}, d_{K}, d_{lc}, dₗₘ) and the ink amount set φ^{-h}(d_{C}−h, d_{Y}, d_{K}, d_{lc}, dₗₘ) are set. Then, the ink amount sets φ^{+h} and φ^{-h} are input to the spectral predicting module M13, so that the predictions of the spectral reflectance Rₛ^{+h}(λ) and Rₛ^{-h}(λ) are calculated (averages of Rₛ₃₆₅, Rₛ₃₇₅, Rₛ₃₈₅, . . . in each wavelength section) by the spectral printing model (Equation 1 above). Here, the difference between the predictions of the spectral reflectance Rₛ^{+h}(λ) and Rₛ^{-h}(λ) can be considered as the variation in the prediction of spectral reflectance Rₛ(λ) corresponding to the minute sections (d_{C}+h) to (d_{C}−h) of the C ink amount. Therefore, if it is assumed that the variation in the prediction of spectral reflectance Rₛ(λ) is linear in the minute sections (d_{C}+h) to (d_{C}−h), a partial differential value regarding the C ink can be obtained by {Rₛ^{+h}(λ)−Rₛ^{-h}(λ)}/2h. By similarly carrying out the calculation on each wavelength section, one row (C ink components) of the Jacobian matrix J can be obtained. Paying attention to the MYKlclm inks sequentially, the same calculation is carried out, so that it is possible to obtain the Jacobian matrix J in the vicinity of the ink amount set φ when the selected correcting patch is printed.

As described above, when the Jacobian matrix J is obtained, in step S680, the correction amount calculating module M16 calculates the correction amount vector Δφ (Δd_{C}, Δd_{M}, Δd_{Y}, Δd_{K}, Δd_{lc}, Δdₗₘ) of the ink amount set φ by Equation 6 below:

[Equation 6]

Δφ^{T}=J⁻¹·ΔR^{T} (6)

In Equation 6 described above, J⁻¹ means an inverse matrix of the Jacobian matrix J. When the inverse matrix J⁻¹ is calculated, singular value decomposition is employed which is represented by Equation 7 below:

[Equation 7]

J=U·Σ·V^{T}

J⁻¹=V·Σ⁻¹·U^{T} (7)

In Equation 7 described above, the Jacobian matrix J is first decomposed into matrixes U, Σ, and V^{T}, so that the inverse matrix (pseudo inverse matrix) J⁻¹ can be calculated. Further, the Jacobian matrix J is a matrix in a form of a non-rectangular shape of the number of the wavelength sections (rows)×the number of the inks (columns). However, through the singular value decomposition, the Jacobian matrix J is decomposed into the matrix U of the number of the wavelength sections (rows)×the number of the wavelength sections (columns), the matrix V^{T} of the number of the inks (rows)×the number of the inks (columns), and the matrix Σ which is in a form of the number of the wavelength sections (rows)×the number of the inks (columns) and components other than the diagonal components become zero. In addition, the inverse matrix Σ⁻¹ of the matrix Σ can be obtained by taking reciprocal numbers with respect to the diagonal components of the matrix Σ. In addition, for convenience of processing, when the reciprocal number is smaller than a predetermined threshold value, it is preferable that the reciprocal number is treated as zero.

As described above, when the correction amount vector Δφ of the ink amount set φ is calculated, the correction amount calculating module M16 subtracts the correction amount vector Δφ from the original ink amount set φ used in printing the correcting patch by Equation 8 described below, so that the correction ink amount set φ_{M} is calculated in step S680.

[Equation 8]

φ_{M}=φ−Δφ (8)

When the correction ink amount set φ_{M} is calculated, in step S690, the table correcting module M17 updates the ink amount set φ associated with the paint (paint number), which is currently selected in the index table IDT, by the correction ink amount set φ_{M} (step S700) In step S710, it is determined whether or not all the paints (paint numbers) are selected. When not all paints are selected, the procedure returns to step S610, and a process of correcting the ink amount set φ is performed on the next paint. When all the paints are selected, the index table IDT, in which all the components of the ink amount set φ are updated by the correction ink amount set φ_{M}, is transmitted to the computer 20 of the agency store. Therefore, it is possible to print the sample sheet SS in the computer 20 of the agency store using the corrected index table IDT. Since the index table IDT is effective only in the apparatus of the printer 28a which prints the color chart, the index table IDT is associated with the apparatus number which is printed on the color chart. As a result, it is possible to refer to the index table IDT corresponding to the apparatus which is designated to actually print the sample sheet SS.

In the sample sheet SS printed on the basis of the correction ink amount set φ_{M}, the printing can be realized to supplement the deviation ΔR(λ) described above. In addition, the target spectral reflectance Rₜ(λ) can be reproduced with high accuracy. In the following, the principle will be described with reference to FIG. 21. The slope characteristics of the prediction of spectral reflectance Rₛ(λ) by the spectral printing model in the vicinity of the ink amount set φ of the correction object, which is used when each correcting patch is printed, can be considered to be similar to the slope characteristics of the correcting spectral reflectance R_{c}(λ) obtained by actually measuring the correcting patch. This is because the absolute value of the actually printed correcting spectral reflectance R_{c}(λ) is shifted due to time degradation or an individual error of the printer 28a in most cases, but the relative variability characteristics between the ink amount sets φ which are approximated to each other is not largely changed. In addition, it can be assumed that the change in the minute section is linear.

As shown in FIG. 21, the correction ink amount set φ_{M} with which the target spectral reflectance Rₜ(λ) is actually reproducible becomes the value which represents the target spectral reflectance Rₜ(λ) of the curve (which is illustrated with a solid line) which passes through the correcting spectral reflectance R_{c}(λ). However, since the correcting spectral reflectance R_{c}(λ) is obtained only on the ink amount set φ of the correction object which is used when each correcting patch is printed, the correcting spectral reflectance R_{c}(λ) is not obtained for any ink amount set φ. Therefore, it is impossible to directly calculate the correction ink amount set φ_{M}, with which the target spectral reflectance Rₜ(λ) is actually reproducible, on the basis of the correcting spectral reflectance R_{c}(λ). For this reason, the curve (which is illustrated with a broken line) of the prediction of spectral reflectance Rₛ(λ) is first obtained on the basis of the spectral printing model which can obtain the prediction of spectral reflectance Rₛ(λ) with respect to any ink amount set φ. Then, the Jacobian matrix J representing the slope in the vicinity of the ink amount set φ of the correction object, which is used when the correcting patch is printed, is calculated in the curve.

As described above, in the curve of the actual correcting spectral reflectance R_{c}(λ) which is illustrated with a broken line and the curve of the prediction of spectral reflectance Rₛ(λ) based on the spectral printing model, the absolute values are shifted, but the relative variability characteristics can be considered to be similar to each other. Therefore, the curve of the actual correcting spectral reflectance R_{c}(λ) can be also estimated as having the same slope. If the slope of the actual correcting spectral reflectance R_{c}(λ) is estimated in this way, it can be considered that a linear relationship shown in Equation 6 is satisfied among the deviation ΔR(λ), the correction amount vector Δφ necessary to supplement the deviation ΔR(λ), and the Jacobian matrix J representing the slope. Then, by solving Equation 6 regarding the correction amount vector Δφ to subtract the correction amount vector Δφ from the original ink amount set φ, it is possible to obtain the correction ink amount set φ_{M} with which the target spectral reflectance Rₜ(λ) is actually reproducible. Further, the Jacobian matrix J is configured of the row components for each plural wavelength section. However, by solving Equations 6 and 7, it is possible to obtain the correction ink amount set φ_{M} with which the deviation ΔR(λ) of each wavelength is decreased just like the least-square method. Hereinbefore, description is made about the calculation carried out by the determinant, but the calculations equivalent to Equations 5 to 8 may be carried out. In addition, the Jacobian matrix J also is not necessarily limited to Equation 5, but the calculations equivalent to Equations 6 to 8 may be carried out by using an equation or a matrix equivalent to the Jacobian matrix J.

### G. SPECTRAL PRINTING MODEL

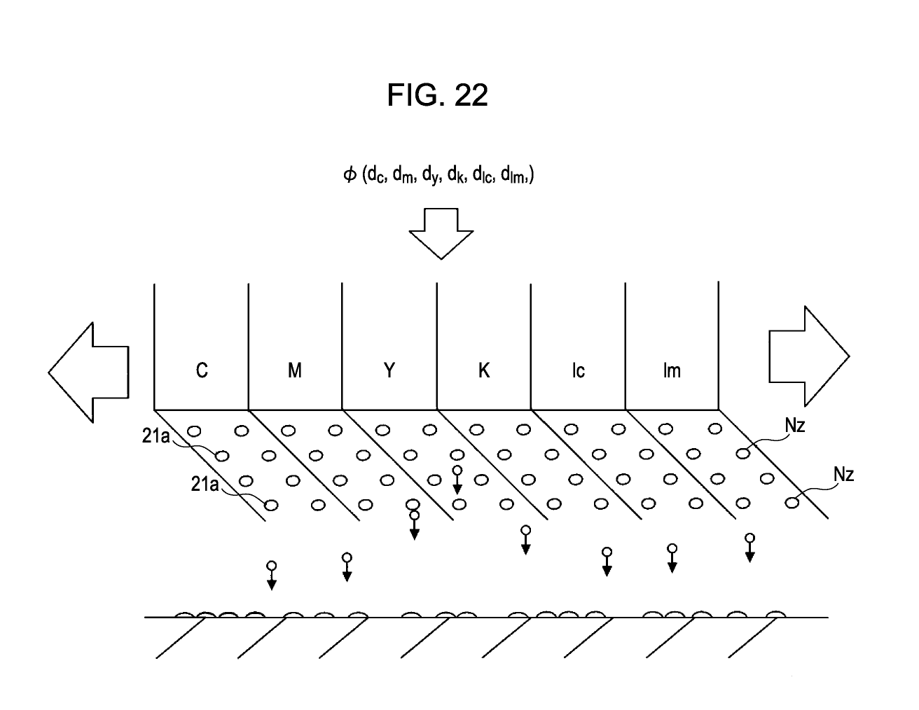

FIG. 22 schematically shows the printing scheme of the printer 28a (18a) according to this embodiment. The printer 28a is provided with a print head HD which is provided with plural nozzles NZ, NZ, . . . in every CMYKlclm ink. The printer is controlled such that the ink amounts of the CMYKlclm inks ejected by the nozzles NZ, NZ, . . . become amounts designated by the above-mentioned ink amount set φ (d_{c}, dₘ, d_{y}, dₖ, d_{lc}, dₗₘ) on the basis of the print data PD. Ink droplets ejected by the respective nozzles NZ, NZ, . . . become minute dots on the print paper, and a large number of dots are collected to form the print image with ink area coverage according to the ink amount set φ (d_{c}, dₘ, d_{y}, dₖ, d_{lc}, dₗₘ) on the print paper.

A prediction model (spectral printing model) used by the spectral predicting module M13 is a prediction model for predicting the spectral reflectance R(λ) by the prediction of spectral reflectance Rₛ(λ) when the printing is carried out at any ink amount set φ (d_{c}, dₘ, d_{y}, dₖ, d_{lc}, dₗₘ) which can be used in the printer 28a according to this embodiment. The prediction model corresponds to the function PM(φ) of Equation 1. In the spectral printing model, the spectral reflectance database RDB is prepared which is obtained by printing the color patch by the standard machine (printer 18a) as to plural representative points in the ink amount space and by measuring the spectral reflectance R(λ) thereof by the spectral reflectometer. Then, the prediction is carried out by the cellular Yule-Nielsen Spectral Neugebauer Model in which the spectral reflectance database RDB is used, so that the spectral reflectance R(λ) is predicted when the printing is accurately carried out at any ink amount set φ (d_{c}, dₘ, d_{y}, dₖ, d_{lc}, dₗₘ).

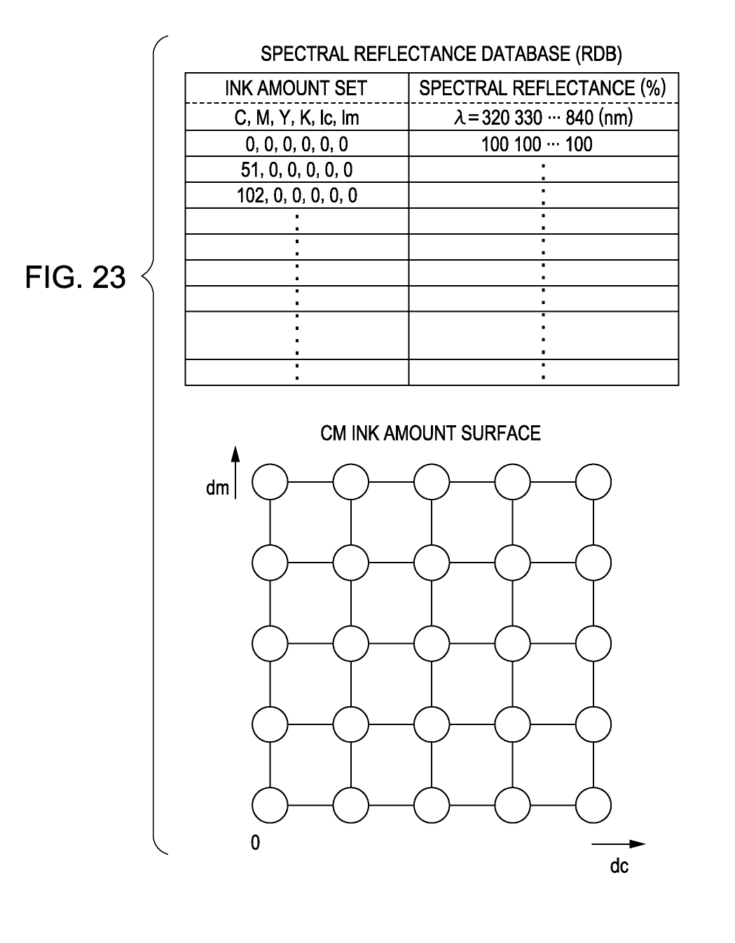

FIG. 23 shows the spectral reflectance database RDB. As shown in the drawing, the spectral reflectance database RDB is a lookup table in which the spectral reflectance R(λ) is stored. The spectral reflectance R(λ) is obtained by actually performing the printing and the measuring on the ink amount set φ (d_{c}, dₘ, d_{y}, dₖ, d_{lc}, dₗₘ) of plural grid points in the ink amount space (six dimensions in this embodiment, but only the CM surface is illustrated for simplification of the drawing). For example, 5 grid points dividing each ink amount axis are generated. Here, 5¹³ grid points are generated, and a vast amount of the color patches are necessarily printed and measured. However, since the printer 28a actually has limitations on the number of the inks capable of being mounted at the same time or the control of the ink duty capable of ejecting at the same time, the number of the grid points used in the printing and the measuring is reduced.

In addition, only a part of the grid points is used for the printing and the measuring, and the spectral reflectance R(λ) of the other grid points is predicted on the basis of the spectral reflectance R(λ) of the grid points which are actually used to perform the printing and the measuring, so that the number of the color patches on which the printing and the measuring are actually performed may be reduced. The spectral reflectance database RDB is necessary to prepare for every print paper with which the printer 28a can perform printing. Strictly speaking, this is because the spectral reflectance R(λ) is determined by the spectral transmittance and the reflectance of the print paper which are caused by an ink film (dot) formed on the print paper, and is strongly influenced by the surface property (the dot shape depends thereon) or the reflectance of the print paper. Next, the prediction by the cellular Yule-Nielsen Spectral Neugebauer Model in which the spectral reflectance database RDB is used will be described.

The spectral predicting module M13 performs the prediction by the cellular Yule-Nielsen Spectral Neugebauer Model in which the spectral reflectance database RDB is used. In this prediction, the print paper (the glossy paper in this embodiment) and the ink amount set φ are set as the print conditions. When the prediction is carried out on the glossy paper as the print paper, the spectral reflectance database RDB which is created by printing the color patch on the glossy paper is set.

When the setting of the spectral reflectance database RDB is complete, the ink amount set φ (d_{c}, dₘ, d_{y}, dₖ, d_{lc}, dₗₘ) output from the ink amount set calculating module M12 or the correction amount calculating module M16 is applied to the spectral printing model. The cellular Yule-Nielsen Spectral Neugebauer Model is based on the spectral Neugebauer model and the Yule-Nielsen model, which are well known. Further, in the following description for simple description, a model in which 3 kinds of inks of CMY are used will be described. The same model is easily extended to a model using any ink amount set including the CMYKlclm according to this embodiment. In addition, as to the cellular Yule-Nielsen Spectral Neugebauer Model, Color Res Appl 25, 4-19, 2000 and R Balasubramanian, Optimization of the spectral Neugebauer model for printer characterization, J. Electronic Imaging 8(2), 156-166(1999) are cited.

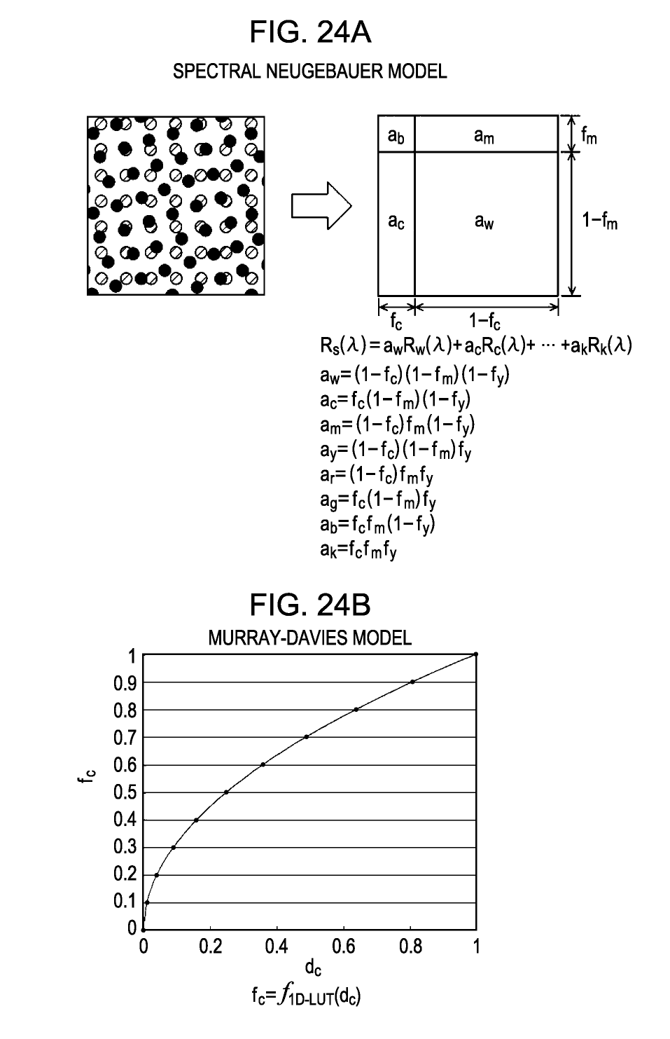

FIG. 24A is a view illustrating the spectral Neugebauer model. In the spectral Neugebauer model, the prediction of spectral reflectance Rₛ(λ) when the printing is performed at any ink amount set (dc, dm, dy) is given by Equation 9 below:

[Equation 9]

Rₛ(λ)=α_{w}R_{w}(λ)+α_{c}R_{c}(λ)+αₘRₘ(λ)+α_{y}R_{y}(λ)+αᵣRᵣ(λ)+α_{g}R_{g}(λ)+α_{b}R_{b}(λ)+αₖRₖ(λ) (9)
α_{w}=(1−f_{c})(1−fₘ)(1−f_{y})
α_{c}=f_{c}(1−fₘ)(1−f_{y})
αₘ=(1−f_{c})fₘ(1−f_{y})
α_{y}=(1−f_{c})(1−fₘ)f_{y}
αᵣ=(1−f_{c})fₘf_{y}
α_{g}=f_{c}(1−fₘ)f_{y}
α_{b}=f_{c}fₘ(1−f_{y})
αₖ=f_{c}fₘf_{y}

Here, aᵢ is an area ratio of the i-th region, and Rᵢ(λ) is the spectral reflectance of the i-th region. The suffix “i” means a region (w) of no ink, a region (c) of the cyan ink only, a region (m) of the magenta ink only, a region (y) of the yellow ink only, a region (r) on which the magenta ink and the yellow ink are ejected, a region (g) on which the yellow ink and the cyan ink are ejected, a region (b) on which the cyan ink and the magenta ink are ejected, and a region (λ) on which 3 colors of the CMY inks are ejected. In addition, f_{c}, fₘ, and f_{y} are the proportions of the areas (called as “ink area coverage”), and each of which is covered with the ink when only one kind of the CMY inks is ejected.

The ink area coverage f_{c}, fₘ, and f_{y} are given by the Murray-Davies model shown in FIG. 24B. In the Murray-Davies model, for example, the ink area coverage f_{c} of the cyan ink is a nonlinear function of the ink amount d_{c} of the cyan ink. For example, the ink amount d_{c} can be converted into the ink area coverage f_{c} by a one-dimensional lookup table. The reason that ink area coverage f_{c}, fₘ, and f_{y} are the nonlinear function of the ink amounts d_{c}, dₘ, and d_{y} is that when a small amount of ink is ejected onto a unit area, the ink spreads sufficiently, whereas when a large amount of ink is ejected, the inks overlap with each other so that there is not much increase in the covered area. The other kinds of the MY inks are also the same.

When the Yule-Nielsen model is applied in relation to the spectral reflectance, Equation 9 described above is rewritten as Equation 10a or Equation 10b below:

[Equation 10]

Rₛ(λ)^{1/n}=α_{w}R_{w}(λ)^{1/n}+α_{c}R_{c}(λ)^{1/n}+αₘRₘ(λ)^{1/n}+α_{y}R_{y}(λ)^{1/n}+αᵣRᵣ(λ)^{1/n}+α_{g}R_{g}(λ)^{1/n}+α_{b}R_{b}(λ)^{1/n}+αₖRₖ(λ)^{1/n} (10a)

Rₛ(λ)={α_{w}R_{w}(λ)^{1/n}+α_{c}R_{c}(λ)^{1/n}+αₘRₘ(λ)^{1/n}+α_{y}R_{y}(λ)^{1/n}+αᵣRᵣ(λ)^{1/n}+α_{g}R_{g}(λ)^{1/n}+α_{b}R_{b}(λ)^{1/n}+αₖRₖ(λ)^{1/n}}ⁿ (10b)

Here, n is a predetermined coefficient equal to or more that 1, and for example, n can be set to 10. Equation 10a and Equation 10b are equations representing the cellular Yule-Nielsen Spectral Neugebauer Model.

The cellular Yule-Nielsen Spectral Neugebauer Model employed in this embodiment is obtained by dividing the ink color space of the Yule-Nielsen Spectral Neugebauer Model described above into plural cells.

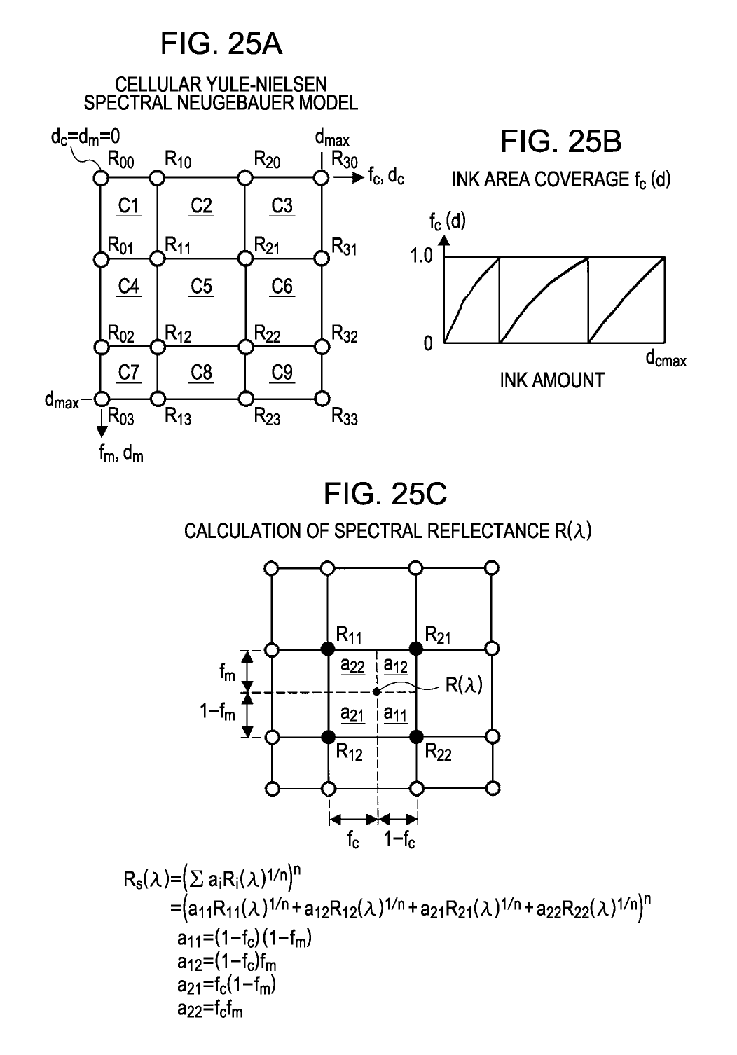

FIG. 25A shows an example of cell division in the cellular Yule-Nielsen Spectral Neugebauer Model. Here, for simple description, the cell division is illustrated in a two-dimensional ink amount space including two axes of the ink amount d_{c} and dₘ of the CM inks. Further, since the ink area coverage f_{c} and fₘ uniquely relate to the ink amount d_{c} and dₘ in the Murray-Davies model described above, the ink area coverage f_{c} and fₘ may be considered as the axes representing the ink area coverage f_{c} and fₘ. The white circles are the grid points (called as “lattice points”) in the cell division. The two-dimensional ink amount (coverage) space is divided into nine cells C1 to C9. The ink amount set (d_{c}, dₘ) corresponding to each lattice point is the ink amount set corresponding to the lattice point defined in the spectral reflectance database RDB. That is, by referring to the spectral reflectance database RDB described above, the spectral reflectance R(λ) of each lattice point can be obtained. Therefore, the spectral reflectance R(λ)₀₀, R(λ)₁₀, R(λ)₂₀, . . . R(λ)₃₃ of each lattice point can be acquired from the spectral reflectance database RDB.

In practice, the cell division in this embodiment also is carried out in the six-dimensional ink amount space of the CMYKlclm inks, and the coordinates of each lattice point also are expressed by the six-dimensional ink amount set φ (d_{c}, dₘ, d_{y}, dₖ, d_{lc}, dₗₘ) Then, the spectral reflectance R(λ) of each lattice point corresponding to the ink amount set φ (d_{c}, dₘ, d_{y}, dₖ, d_{lc}, dₗₘ) of each lattice point is acquired from the spectral reflectance database RDB (for example, the spectral reflectance database of the glossy paper).

FIG. 25B shows a relationship between the ink area coverage f_{c} and the ink amount d_{c} which are used in the cell division model. Here, the ink amount range 0 to d_{cmax} of one kind of ink is also divided into three sections, and the virtual ink area coverage f_{c} used in the cell division model is obtained by the nonlinear curve which increases monotonically from 0 to 1 in every section. The ink area coverage fₘ and f_{y} are also obtained in the same manner.

FIG. 25C shows a calculation method of the prediction of spectral reflectance Rₛ(λ) when the printing is performed at any ink amount set (d_{c}, dₘ) in a cell C5 located at the center position shown in FIG. 25A. When the printing is performed at the ink amount set (d_{c}, dₘ), the spectral reflectance R(λ) is given by Equation 11 below:

$$\begin{matrix}[ Equation 11 ] & \\ \begin{matrix}{R}_{s} ( λ ) = {( \sum {a}_{l} {{R}_{l} ( λ )}^{1 / n} )}^{n} \\ = {( \begin{matrix}{a}_{11} {{R}_{11} ( λ )}^{1 / n} + {a}_{12} {{R}_{12} ( λ )}^{1 / n} + \\ {a}_{21} {{R}_{21} ( λ )}^{1 / n} + {a}_{22} {{R}_{22} ( λ )}^{1 / n}\end{matrix} )}^{n}\end{matrix} \\ {a}_{11} = ( 1 - {f}_{c} ) ( 1 - {f}_{m} ) \\ {a}_{12} = ( 1 - {f}_{c} ) {f}_{m} \\ {a}_{21} = {f}_{c} ( 1 - {f}_{m} ) \\ {a}_{22} = {f}_{c} {f}_{m} & ( 11 )\end{matrix}$$

Here, in Equation 11, the ink area coverage f_{c} and fₘ are values given by the graph shown in FIG. 25B. In addition, the spectral reflectance R(λ)₁₁, (λ)₁₂, (λ)₂₁, and (λ)₂₂ corresponding to four lattice points surrounding the cell C5 can be acquired by referring to the spectral reflectance database RDB. Therefore, all the values constituting the right side of Equation 11 can be confirmed, and as the calculation result, when the printing is performed at any ink amount set φ (d_{c}, dₘ), the prediction of spectral reflectance Rₛ(λ) can be calculated. The wavelength λ is sequentially shifted in the visible wavelength band, so that the prediction of spectral reflectance Rₛ(λ) can be obtained in the visible wavelength band. When the ink amount space is divided into plural cells, the prediction of spectral reflectance Rₛ(λ) can be calculated with high accuracy compared with the case of no division. As described above, the spectral predicting module M13 can predict the prediction of spectral reflectance Rₛ(λ) according to the request of the ink amount set calculating module M12 or the correction amount calculating module M16.

### H. MODIFIED EXAMPLE

### H1. First Modified Example

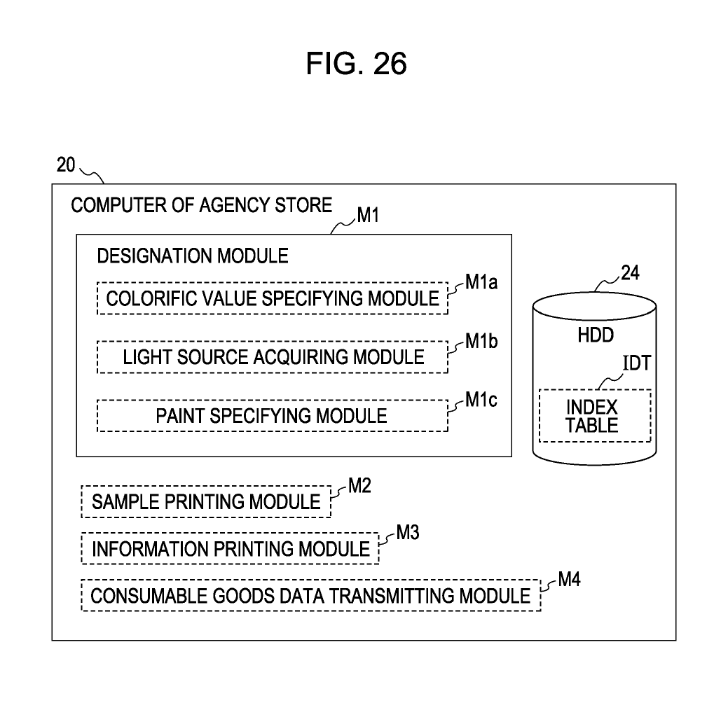

FIG. 26 shows a configuration of the designation module M1 according to this modified example. In this modified example, the designation module M1 is configured to include the colorific value specifying module M1a, the light source acquiring module M1b, and the paint specifying module M1c. In this modified example, the designation of the paint is indirectly accepted from the paint purchaser by performing a process to be described below instead of step S110 in the embodiment described above.

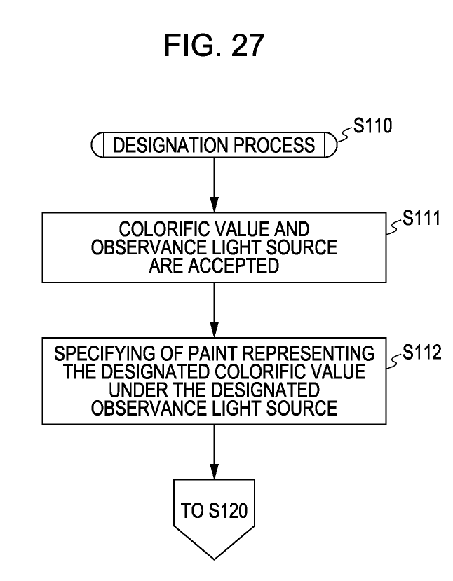

FIG. 27 shows a flow of the designation process which is performed instead of step S110 in the embodiment described above. In step S111, the colorific value specifying module M1a and the light source acquiring module M1b display the UI image to accept the designation of the colorific value and the observance light source from the paint purchaser. Here, the designation of the colorific value in the absolute color space is accepted. For example, the designation of the colorific value is accepted from the paint purchaser, which corresponds to the coordinate values in the CIELAB color space or the XYZ color space. In this embodiment, it is assumed that the designation of the colorific value is accepted which corresponds to the XYZ values (tristimulus values) in the XYZ color space. In addition, the observance light source is a light source under the circumstances of the existing object to be coated with the paint by the paint purchaser, and in this embodiment it can be designated to be the exterior or the interior.

The paint specifying module M1c specifies the XYZ values designated in step S111, and the paint to be realized under the designated observance light source (step S112). Since the target spectral reflectance Rₜ(λ) obtained by measuring each paint is stored in the index table IDT shown in FIG. 8, it is possible to specify which paint has the designated colorific value under the designated observance light source. Specifically, the XYZ values represented by any target spectral reflectance Rₜ(λ) can be calculated by Equation 12 below:

[Equation 12]

X=k∫P(λ)Rₜ(λ)x(λ)dλ

Y=k∫P(λ)Rₜ(λ)y(λ)dλ

Z=k∫P(λ)Rₜ(λ)z(λ)dλ (12)

In Equation 12, P(λ) denotes the spectral energy of the designated observance light source, and k denotes a coefficient for normalization. As the spectral energy P(λ) at the exterior, the D65 light source may be used, for example. On the other hand, as the spectral energy P(λ) at the interior, the F11 light source such as a fluorescent lamp may be used, for example. The spectral energy P(λ) of the D65 light source and the F11 light source has a quite different spectrum, and the calculated XYZ values are also different from each other. Further, in this embodiment, the interior is treated with the F11 light source. Furthermore, a lamp light source (an A light source, etc.) may be designated in detail.

In addition, the spectral energy P(λ) of the D65 light source and the F11 light source is also known as standardized data, so that the spectral energy P(λ) can be previously stored in the HDD 24 and can be used by the paint specifying module M1c reading therefrom. The paint specifying module M1c carries out the calculation of Equation 12 on the target spectral reflectance Rₜ(λ) of each paint defined in the index table IDT and the designated spectral energy P(λ), and calculates the XYZ values for each paint. Then, the paint specifying module M1c specifies a paint of which the values calculated by Equation 12 most approximate to the XYZ values designated by the paint purchaser. For example, it is possible to determine whether or not the calculated values are most approximate to the XYZ values designated by the paint purchaser using a Euclidean distance in the XYZ color space. As a result, it is possible to obtain the paint representing the most approximated color to the XYZ values which are designated by the paint purchaser in the observance light source designated by the paint purchaser.

When the desired paint of the paint purchaser is specified, the procedure may proceed after step S120 of the sample sheet printing process of the above-mentioned embodiment. As a result, it is possible to print the sample sheet SS which has the sample region SA with the spectral reflectance characteristics approximating to the paint which the paint purchaser has designated using the colorific value. By this, for example, the invention can be performed on the agency store in which the paint samples are disposed. However, it is preferable that the paint purchaser can recognize the color which is desired by the paint purchaser using the colorific value, but it may be expected that it is difficult to designate the paint because it is generally not familiar with the colorific value. Here, the next modified example discloses a method of further easily designating the colorific value.

### H2. Second Modified Example

In the previous modified example, the colorific value is directly designated. However, it may be configured such that a calorimeter as the image input apparatus of the invention is connected to the computer 20 of the agency store to use the colorimetric value obtained by the calorimeter as the colorific value of the modified example described above. For example, the color of the object taken back from the paint purchaser's own house is measured to specify the paint which is used to print the sample sheet SS on the basis of the colorimetric value. Basically, the colorific value acquired by the colorific value specifying module M1a of the previous modified example may be replaced with the colorimetric value. In this case, it may also be considered that the favorite colored object which the paint purchaser takes back from the own house is changed into a different color under the light source in the agency store. Furthermore, after measuring the color under the light source different from the light source under which the paint purchaser observes the object in his or her own house, a sample sheet SS having an unintended color is printed. For this reason, it is preferable that the kind of the light source under which the paint purchaser observes the object be designated and the color measurement be performed under the designated light source. The scanner may be used instead of the calorimeter. In this case, it is preferable that the calibration is performed on the scanner. Further, the spectral reflectometer may be provided in the computer 20 of the agency store. In this case, it is sufficient that the paint of which the spectral reflectance is similar is specified, and there is no need to consider the difference in the light source.

### H3. Third Modified Example

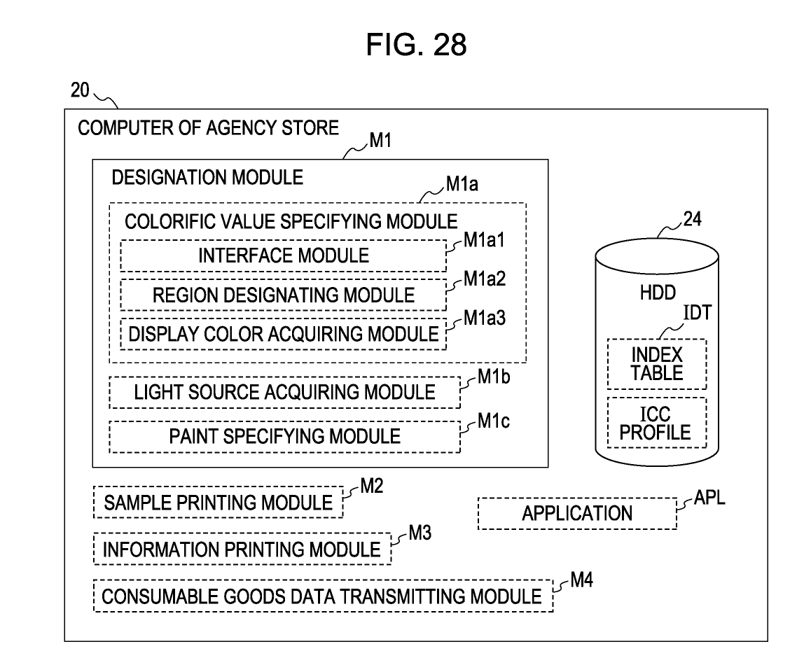

FIG. 28 shows a configuration of the designation module M1 according to this modified example. Also in this modified example, the designation module M1 is configured to include a colorific value specifying module M1a, a light source acquiring module M1b, and a paint specifying module M1c. In this case, the colorific value specifying module M1a is configured to further include an interface module M1a1, a region designating module M1a2, and a display color acquiring module M1a3.

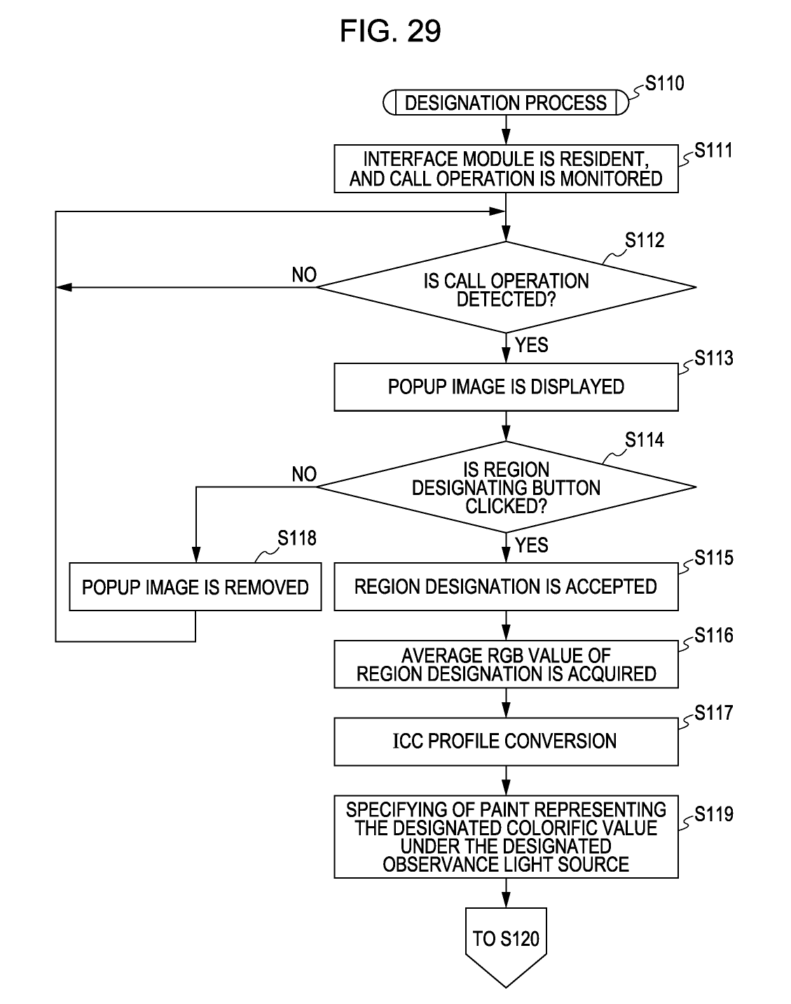

FIG. 29 shows a flow of the designation process performed instead of step S110 in the above-mentioned embodiment. In step S111, the interface module M1a1 starts. The interface module M1a1 is a resident module, and starts when an OS (not shown) starts on the computer 20, and then runs continuously. The OS is a multitasking OS. Even when the application APL shown in FIG. 28 is starting, the interface module M1a1 runs in the background. The interface module M1a1 monitors a predetermined operation (hereinafter, denoted as a call operation) of the input device I/F 27 or the keyboard 27a when other applications APL are running.

For example, when a browser is running as the application APL, it is monitored that the call operation is accepted from the keyboard 27a. For example, it is monitored that a single or plural keys of the keyboard 27a are pressed. In addition, icons are displayed on a part of the display 26a and it may be monitored that the icons are clicked by the mouse 27b. In step S112, it is determined whether or not the call operation is detected. When the call operation is detected, the interface module M1a1 prompts the region designating module M1a2 to start in step S113. Then, the region designating module M1a2 displays a popup image on the display 26a to designate the region.

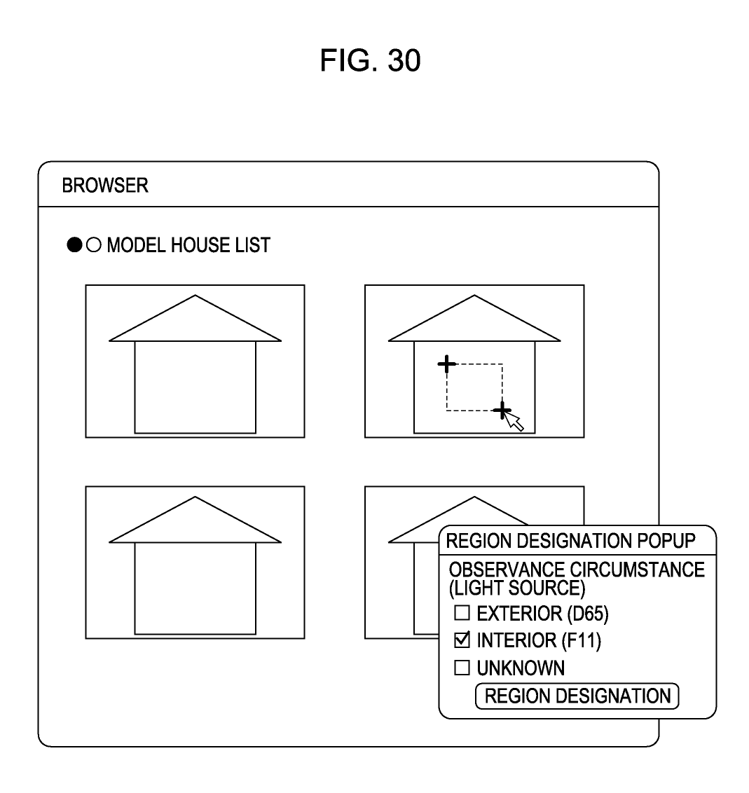

FIG. 30 shows an example of the popup image. In this drawing, the browser as the application APL browses the WEB pages (data which can be rendered by the browser) which are uploaded on the Internet INT. In the WEB pages, image data is included, and images displayed by the image data are displayed on the display 26a by the browser. The popup image is displayed to be overlapped with the image displayed by the browser. In the popup image, there are provided with a region designating button, a cancel button, and check boxes which are used to designate whether the observation light source is the exterior or the interior. In step S114, it is determined whether or not the region designating button is clicked by the mouse 27b. At the same time, the observation light source designated in the popup image is acquired.

When it is determined that the region designating button is clicked, the region designating module M1a2 accepts the designation of the region on the display 26a by a drag-and-drop function carried by the mouse 27b in step S115. In FIG. 30, a region is shown as an example, which is designated by the function of drag-and-drop function from an upper left corner to a lower right corner in a rectangular shape. Of course, the designated region is not limited to the rectangular shape, but a circle or an ellipsoid shape may be employed as well as various kinds of diagrams. In the example shown in FIG. 30, the image is displayed by the browser, and the region can be designated in the image. In addition, the display 26a corresponds to an image output apparatus according to the invention.

In step S116, the display color acquiring module M1a3 acquires an average color displayed in the region which is designated on the display 26a. The display image data output on the display 26a is accumulated in buffers of the RAM 22 or the VRAM of the video I/F 26. The average color displayed in the region which is designated on the display 26a is acquired on the basis of the display image data. In this embodiment, each pixel of the display image data accumulated in the buffers is expressed as the RGB values in the sRGB color space. The display color acquiring module M1a3 extracts the pixel corresponding to the designated region from the display image data, and takes an average of the RGB values, and thus the average color displayed in the designated region is acquired.

The average value of the RGB values means a constant value in the sRGB color space, but is not limited to the color matched with the color actually displayed on the display 26a (the color viewed by the paint purchaser). This is because the display 26a has a unique color reproduction gamut different from the gamut of the sRGB color space. Therefore, when a mapping is performed between these gamuts, image correction may be performed according to the display characteristics of the display 26a. For this reason, the display color acquiring module M1a3 acquires an (output) ICC profile of the display 26a in step S117, and specifies the color actually displayed on the display 26a on the basis of the ICC profile. The ICC profile is a profile which defines a correspondence relationship between the RGB value input in the display 26a and the color actually displayed on the display 26a, and is stored on the HDD 24 in advance.

For example, when the program performing the sample sheet printing process is installed, the corresponding ICC profile may be downloaded from the Internet INT by designating the model of the display 26a to be used. In this embodiment, the color which is actually displayed on the basis of the average value of the RGB value in the designated region is acquired as XYZ values on the basis of the ICC profile. Then, it is also conceivable that the display characteristics of the display 26a are excessively deviated from the ICC profile due to the individual error or the time degradation in the display 26a. In this case, the color deviated from the color which is designated by the paint purchaser after actual identification is specified. For this reason, it is preferable that the display 26a is subjected to a calibration so as to actually match the display color of the display 26a with the color defined by the ICC profile.

As described above, the XYZ values and the observance light source which are desired by the paint purchaser can be acquired. Thereafter, similar to the modified example described above, the paint representing the XYZ values under the observance light source is specified (step S119), and the sample sheet SS can be printed. On the other hand, in step S113, when it is determined that the region designating button is not clicked by the mouse 27b but the cancel button is clicked, or when no operation is carried out during a predetermined period, the popup image is erased (step S118), and then a predetermined operation is monitored (step S112).

In this modified example, it is possible to designate the favorite color by designating the region when the paint purchaser finds out the favorite color in the image which is displayed on the display 26a by the application APL such as the browser. Therefore, there is no need to grasp the colorific value of the favorite color. In addition, there is no need to prepare the sample of the paint in the agency store. For example, by browsing WEB pages which include many images of houses of building companies, it is possible for the paint purchaser to find out the paint to coat the roof of the own house. Further, when the calibration is not completely performed in this modified example, the display color of the display 26a is also incorrect, so that the designation of the color by the paint purchaser is also incorrect.

For this reason, in consideration of deviation in the display color of the display 26a, several paints displaying colors approximating to the XYZ values desired by the paint purchaser are specified as well as the most approximated color, and the sample sheets SS of these may be printed, respectively. In this case, even when the display color of the display 26a is deviated, it is possible to select the most ideal color from among plural sample sheets SS. Further, the kinds of the application APL is not limited to the browser, but for example, it may be a photo viewer so that the paint purchaser can designate the favorite color in any photograph owned by the paint purchaser. That is, the paint purchaser takes an object of the favorite color using a digital still camera or a scanner, and can designate the corresponding region while browsing the image data. Therefore, the paint purchaser can purchase the paint, with which a color from a favorite landscape photograph is reproducible, to coat a room or the like. In addition, according to the digital still camera, a concave-convex object can be also input as an image. Of course, a word processor or an application for the CG creation can also designate the favorite color. However, it may be also considered that the deviation occurs between the actual color of the object taken by the digital still camera and the object color displayed on the display 26a by the photo viewer. When the paint purchaser wants the paint having the color currently displayed on the display 26a, the deviation is not a problem. However, when the paint purchaser wants the paint having the color of the object itself, the sample sheet SS may be printed with the paint which is different from the intended paint. For this reason, by preparing a profile defining the correspondence relationship between the colorific value representing each pixel of the image taken by the digital still camera and the measured value of the actual object, it is preferable to carry out a color matching. Furthermore, a dedicated application APL may be provided which is suitable for designating the region representing the favorite color of the paint purchaser.

### H4. Fourth Modified Example

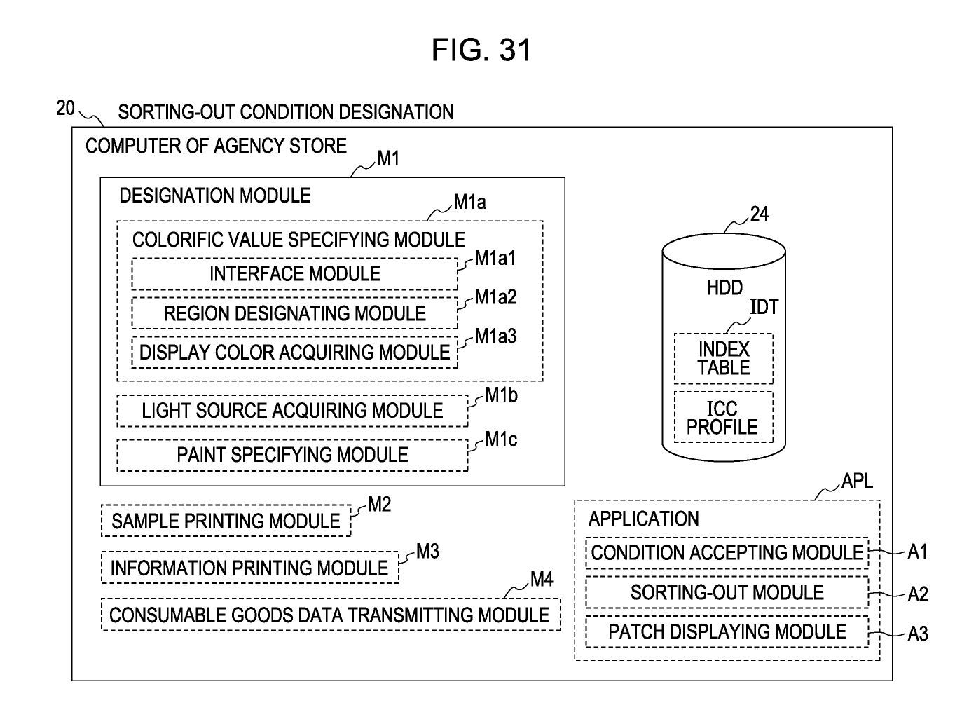

FIG. 31 shows a configuration of the application APL according to this modified example. The configurations of the other modules are the same as those of the third modified example described above. That is, even when the application APL of this modified example is performing, a popup image is displayed to designate the region in the display image which is displayed on the display 26a by the application APL by carrying out the call operation. The application APL is configured of the condition accepting module A1, a sorting-out module A2, and a patch displaying module A3.

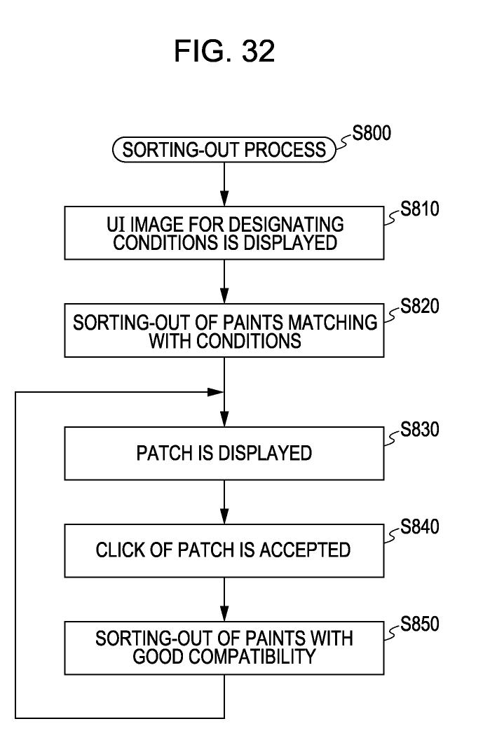

FIG. 32 shows a flow of a sorting-out process performed by the application APL. Also in performing this process, the monitoring of the call operation runs in the background by the interface module M1a1. In step S810, the condition accepting module A1 displays a condition designating image on the display 26a to accept the operation of the keyboard 27a or the mouse 27b.

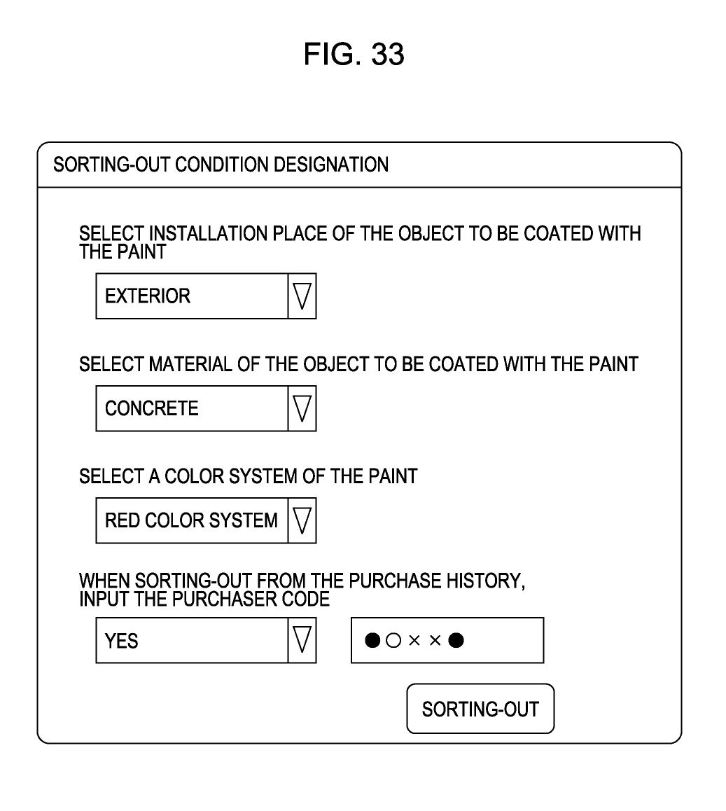

FIG. 33 shows an example of the condition designating image. In the condition designating image, pull down menus are provided to designate the coating object of the paint which the paint purchaser wants to purchase. Specifically, with these menus, the paint purchaser can designate whether the coating object is disposed in the exterior or in the interior, the material of the coating object, and the color system represented by the paint. In addition, a unique purchaser code is assigned to the paint purchaser, so that it is possible to designate whether or not the paint is limited to the own purchaser code and to ones already purchased in the past. In step S820, the sorting-out module A2 sorts out the paints suitable for the designated conditions. In the index table IDT according to this modified example, information is stored to perform the sorting-out on the respect paints.

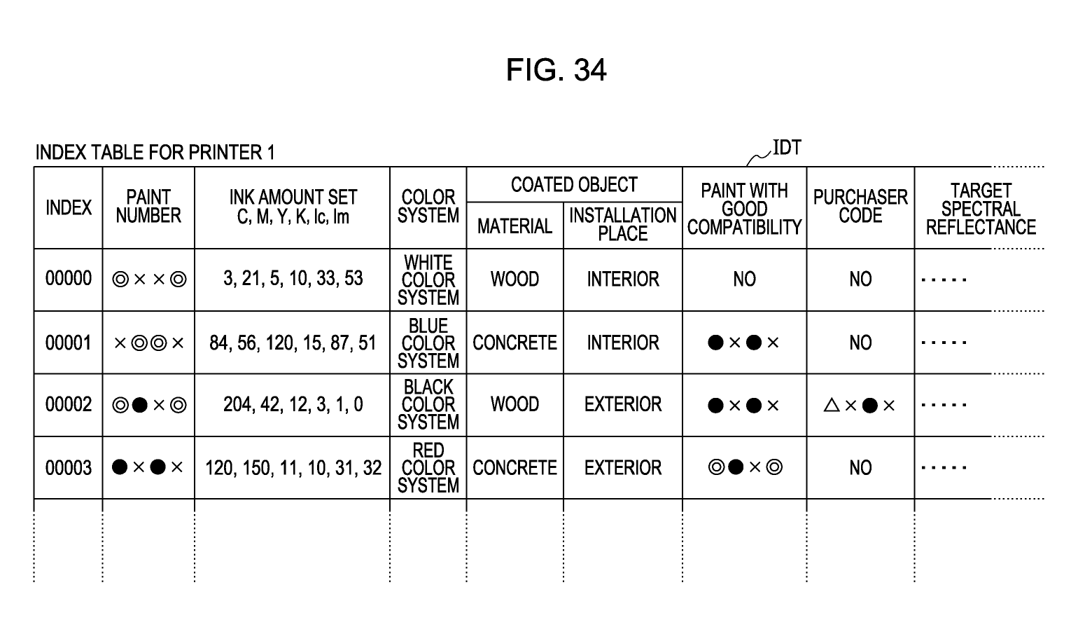

FIG. 34 shows an example of the index table IDT according to this modified example. In the index table IDT, whether the paint is used for the interior or for the exterior (the installation place of the coating object), the material with which the paint can be coated, the color system of the paint, and the purchaser code of the paint purchaser who purchased the paint in the past are stored as the sorting-out keys. In addition, the paints with good compatibility with the respective paints are stored in the index table IDT. The sorting-out module A2 sorts out the paints, which match with the respective items designated by the paint purchaser, by the sorting-out keys described above. In step S830, the patch displaying module A3 displays the patches of the sorted-out paints on the display 26a. When displaying the patches of the sorted-out paints, the observance light source designated as the installation place is first applied to the target spectral reflectance Rₜ(λ) of the sorted-out paints and the XYZ values are calculated by calculating the above Equation 12. Then, the RGB values of the sRGB color space, in which the color equivalent to the XYZ values can be displayed on the display 26a, is specified with reference to the ICC profile described above.

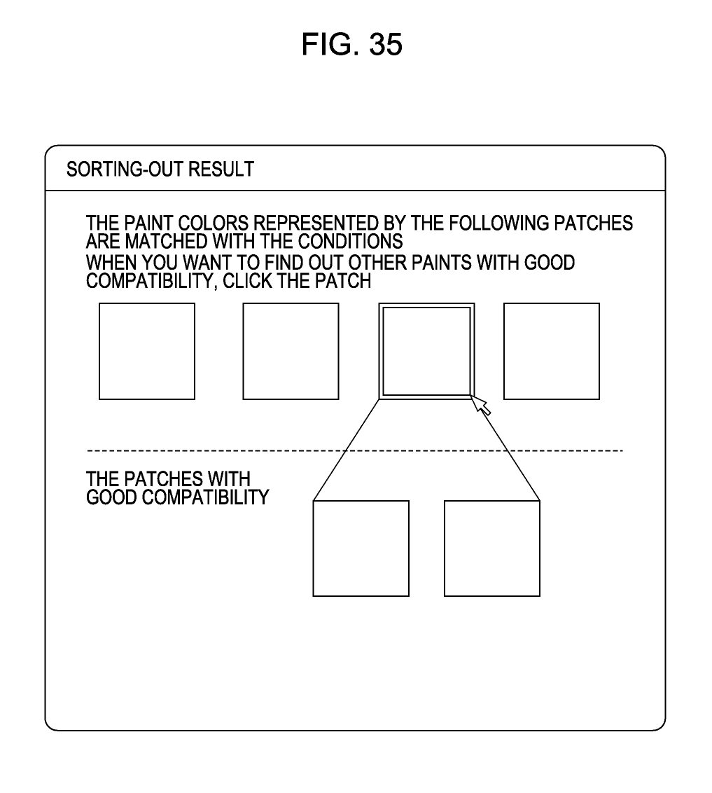

FIG. 35 shows an example of the patches displayed in step S830. In this drawing, the rectangular patches of the colors, which are represented by the plural sorted-out paints under the observance light source designated as the installation place, are arranged on the display 26a. The patches displaying module A3 aligns the pixels, which have the RGB values specified according to the above-mentioned procedure, on the display image data in a rectangular shape, and outputs the display image data to the video I/F 26, so that the patches are displayed on the display 26a. At this point of time, when the paint purchaser finds the favorite color among the patches, the interface module M1a1 makes the popup image by carrying out the call operation for monitoring, so that the paint purchaser can designate the region of the favorite patch. As a result, the process of the third modified example is carried out, and it is possible to print the sample sheet SS of the paint represented by the patch. Further, in the popup image, it may be restricted not to designate a conflicted observance light source.

On the other hand, the patch displayed in step S830 can be clicked by the mouse 27b. In step S840, the clicks of the respective patches are accepted. When the patch is clicked, the sorting-out module A2 sorts out the paint with good compatibility with the clicked patch (step S850). Since the paints with good compatibility with the respective paints are stored in index table IDT, the sorting-out module A2 can sort out the paints using the index table IDT. When the sorting-out is completed, the procedure returns to step S830 to display the patches of the sorted-out paint. At this time, the new patches are displayed in parallel so as to be viewed in contrast to the patches displayed from the beginning. At this point of time, when the paint purchaser finds the favorite color among the patches, the interface module M1a1 makes the popup image by carrying out the call operation for monitoring, so that the paint purchaser can designate the region of the favorite patch. In this way, the paints are sorted out according to the conditions designated by the paint purchaser, so that it is possible to smoothly designate the paints. In particular, when the paint purchaser wants to purchase the same paints as ones already purchased in the past, it is possible to smoothly designate the paints by designating the purchaser code. Also in this case, since the color can be confirmed by the patch, it is possible to prevent designation mistakes.

In addition, the shape of the patch is not limited to the simple rectangular shape, but the shape may be changed such that the patch having the shape (for example, the roof shape of the house) of the object for coating is displayed. That is, if the object for coating is specifically designated when the sorting-out conditions are designated, it is possible to display the patch according to the shape of the object for coating. As a result, the paint purchaser can easily visualize a coated state. In such a configuration, when one patch is clicked in step S840, the patch in the shape of the adjacent object (for example, the wall with respect to the roof of the house) may be displayed by the RGB values of the paint with good compatibility. Then, both patches are displayed in combination with each other, so that the paint purchaser can select the combination of the paints used to print the sample sheet SS while visualizing the color and the shape.

However, the index table IDT used in this modified example is not necessarily stored in the HDD 24 of the computer 20 of the agency store, but the index table IDT may be stored in the HDD 14 of the computer 10 of the paint distributor to be referred via the Internet INT as needed. The index table IDT is managed by the HDD 14 of the computer 10 of the paint distributor, so that it is possible to flexibly respond to the addition of the new paint product. In addition, every time the delivery accounting process is carried out, it is preferable that the purchaser codes of the paint purchasers who purchase the respective paints be filled out. Further, it is preferable that the index table IDT be managed in the HDD 14 of the computer 10 of the paint distributor. In addition, the application APL of this modified example has been described to be performed on the computer 20 of the agency store. However, the computer 10 of the paint distributor actually performs the corresponding processes, and the computer 20 of the agency store may provide only the user interface using the browser or the like.

### H5. Fifth Modified Example

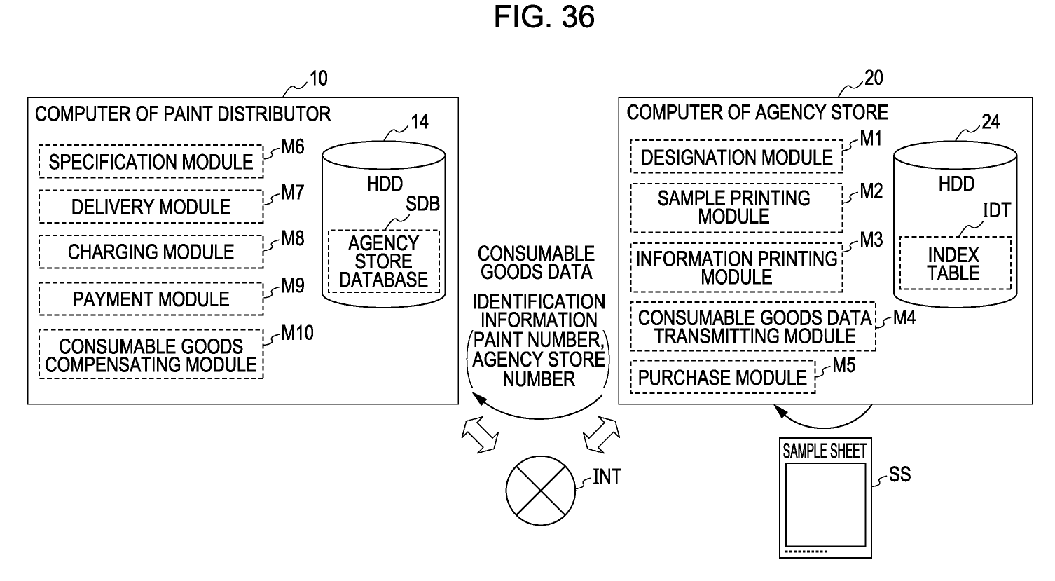

FIG. 36 shows a software configuration of the paint dealing system according to this modified example. In this modified example, the computer 30 of the paint purchaser is not provided, and the purchase module M5 is performed by the computer 20 of the agency store. As a result, it is possible to flexibly respond to a case where the paint purchaser decides to purchase the sample sheet SS immediately after printing, or to a case where the paint purchaser first takes the sample sheet SS to his or her own house and then again returns back to the agency store to purchase it. In this case, a bar-code reader is provided at the computer 20 of the agency store, and a bar code obtained by encoding the paint number and the agency store number is printed on the sample sheet SS, so that it is possible to omit the troublesome inputting of the paint purchaser or the like.

### H6. Sixth Modified Example

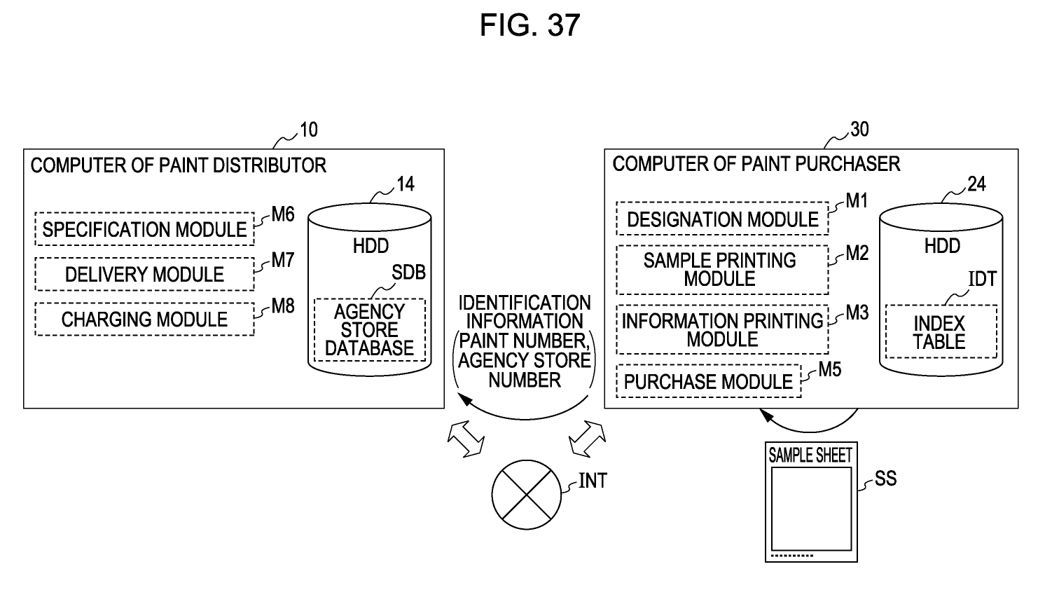

FIG. 37 shows a software configuration of the paint dealing system according to this modified example. In this modified example, the computer 20 of the agency store is not provided, but the designation module M1, the sample printing module M2, and the information printing module M3 which carry out the sample sheet printing process are performed by the computer 30 of the paint purchaser. That is, the sample sheet SS may be printed by the computer 30 of the paint purchaser. In this case, the paint purchaser may not go to the agency store. In this modified example, since the trouble of printing the sample sheet SS and the burden of the consumable goods may be undertaken by the paint purchaser, the consumable goods data transmitting module M4, the payment module M9, and the consumable goods supplementing module M10 are not performed.

### H7. Seventh Modified Example

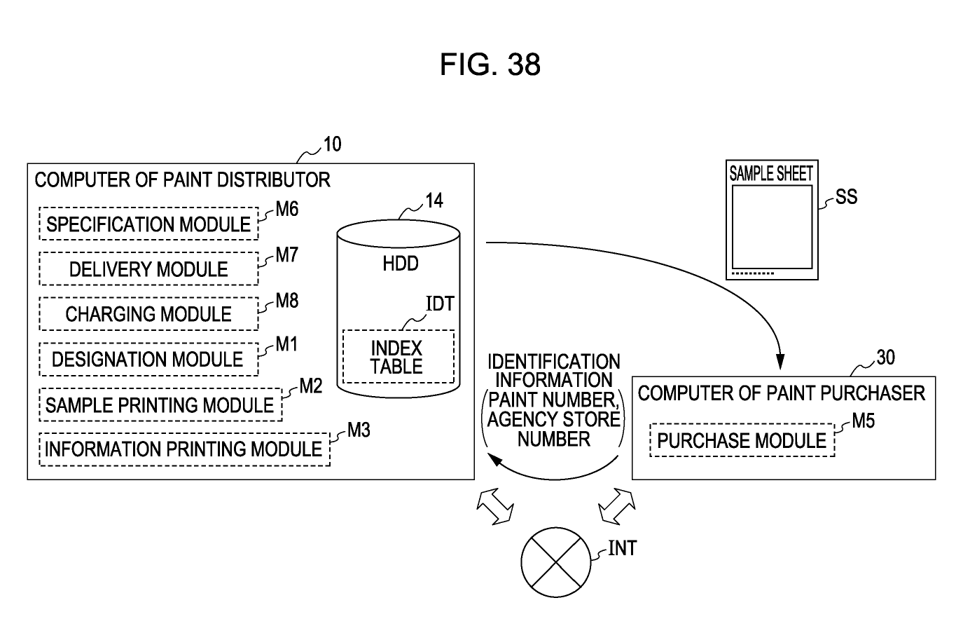

FIG. 38 shows a software configuration of the paint dealing system according to this modified example. In this modified example, the computer 20 of the agency store is not provided, but the designation module M1, the sample printing module M2, and the information printing module M3 which carry out the sample sheet printing process are performed by the computer 10 of the paint distributor. That is, the sample sheet SS may be printed by the computer 10 of the paint distributor. In this modified example, since the trouble of printing the sample sheet SS and the burden of the consumable goods may be undertaken by the paint distributor, the consumable goods data transmitting module M4, the payment module M9, and the consumable goods supplementing module M10 are not performed.

### I. CONCLUSION

As described above, the paint dealing system is formed in which the computers of the purchaser, the distributor, and the agency store are connected to each other via the communication line. The sample printing unit and the information printing unit are provided at the computer of the agency store. In the sample printing unit, the printing apparatus is prompted to print the paint sample. In the information printing unit, the identification information is printed on the sample to identify the paint and the agency store. On the other hand, the computer of the purchaser is provided with the purchasing unit, and the designation of the paint to be purchase is accepted by the purchasing unit in accordance with the identification information, and then the identification information is transmitted to the computer of the distributor. The computer of the distributor is provided with the specification unit, the charging unit, and the payment unit. The specification unit specifies the designated paint and the agency store in which the sample is printed on the basis of the transmitted identification information. The charging unit charges the cost of the designated paint to the purchaser. Then, the payment unit pays the cost of printing the sample to the designated agency store. According to the payment unit described above, in consideration of the contribution of the agency store to the purchase of the paint, it is possible to pay the cost to the agency store.

In addition, even though the cost of printing the sample is paid, all printing of the samples leads to an actual purchase of the paint. That is, it may be considered that, even though the samples are printed in great quantities, these may not lead to an actual purchase of the paint, but this makes the burden of the consumable goods too heavy for the agency store. For this reason, the consumable goods data is transmitted to the computer of the distributor to specify the consumable goods exhausted by printing the samples, so that the distributor can specify the amount of the consumable goods in the agency store. For example, the distributor can supplement the consumable goods or be charged for the price of the consumable goods.

The database is prepared in advance, which defines the correspondence relationship between the paint and the amount of the coloring material used when the printing apparatus prints the sample. Then, the printing apparatus is prompted to print the sample according to the amount of the coloring material obtained by referring to the database. In addition, the amount of the coloring material associated with the paint is corrected in each printing apparatus, so that deviation in reproduction accuracy of the printing apparatus may be suppressed with respect to the sample.

In addition, since the sample is printed according to the request of the paint purchaser, it is preferable that the purchaser can designate which paint is printed as the sample. As such a configuration, the designation unit is prepared to indirectly or directly accept the designation of the paint to print the sample from the purchaser. As a result, when the printing apparatus is prompted to print the sample of the paint designated by the printing unit, it is possible to print the sample of the paint which is intended by the purchaser.

As a specific method of accepting the designation of the paint by the designation unit, the designation of the color may be exemplified. Since the respective paints represent characteristic colors, it can be regarded as that the method is the easiest way to know the designation by the color. However, since the color represented by the paint or the sample has the light-source dependency, when the assumed light source is changed, there is some fear that another color may be designated. For this reason, it is preferable that the designation of the color is accepted from the purchaser and the paint representing a color approximating to the designated color is designated as the designated paint.

In addition, as a specific method of designating the color, the designation of the colorific value may be exemplified. The purchaser can uniquely designate the desired color by designating the colorific value in the absolute color space. However, it may be conceivable that the purchaser does not recognize the desired color as the numerical value of the colorific value. In this regard, the colorific value obtained by inputting an object taken by the image input apparatus as an image is accepted as the designation of the color from the purchaser, so that there is no need to directly designate the colorific value as the numerical value. Furthermore, the colorific value of the color represented by the image output apparatus may be accepted as the designation of the color from the purchaser. For example, it may be configured such that plural patches representing the colors of the plural paints are displayed on the image output apparatus to accept the designation of the paints by selecting the patches.

The specific method of accepting the designation of the paint by the designation unit is not limited to the designation of the color, but the designation may be accepted from another point of view. For example, it may be configured such that information for specifying the paint purchaser is accepted to designate the paint, which is the same or a similar one to the paint designated in the past by the paint purchaser, as the designated paint. In particular, since it is possible to purchase the same paint as that purchased in the past, it is suitable for a case where an insufficient paint is bought to refill that.

In addition, as a preferable specific example of the invention, it is configured such that the image data is generated when the sample is printed by the printing apparatus and the information on the pixels in the region corresponding to the paint sample is stored in order to uniquely specify the paint. In general, the image data subjected to the rendering in printing is configured of the pixels having the information for specifying a predetermined color space of the printing color, but the properties of the paint to be reproduced as the sample are not limited to the color. Specifically, the spectral reflectance or the metamerism of the paint is also to be reproduced, but at the point of time when the pixels is expressed to print the sample with the printing color in the image data, the information on the spectral reflectance or the metamerism is lost. For this reason, also in the rendered image data, the information on the pixels in the region corresponding to the sample is stored to enable the paint to be specified. On the other hand, the pixels of the region, in which the identification information is recorded, may be sufficient to store the information for specifying the printing color in a predetermined color space as usual.

Further, the payment unit may change the amount of the cost of printing the sample according to the quantities of the designated paint. For example, even when the same sample is used, when a small amount of the paints is purchased and when a large amount of the paints is purchased, it is matter of course that the latter case is considered to make a great contribution. Therefore, it is preferable that the latter case is paid with the high cost.

The merchandise of the invention may be sufficient to be reproducible as the sample of the printed material. For example, the paint or the like is reproducible in the state of the coated surface using the sample. Of course, when the sample is a photograph of the merchandise, it is possible to print various samples such as general domestic articles or electrical articles. The combination of such samples is the so-called merchandise catalog. According to the invention, it is possible to provide the system in which the cost of printing the catalog is smoothly accounted.

In addition, the technical idea of the invention is realized by the specific hardware systems or the computers which constitute the system as well as it can be realized as a method carried out on the system. That is, the invention can be also specified as a method which includes processes corresponding to the respective units carried out by the system described above. Of course, when the above-mentioned system reads out programs to realize the respective units described above, it is matter of course that the technical idea of the invention may be realized by programs which perform the functions corresponding to the respective units or by various recording media in which the programs are stored.

What is claimed is:

1. A paint dealing system comprising computers which are provided for a purchaser, a distributor, and an agency store and are connected to each other via a communication line,
wherein the computer of the agency store includes
a sample printing unit that prompts a printing apparatus to print a paint sample, and
an information printing unit that prints identification information on the sample to identify the paint and the agency store,
wherein the computer of the purchaser includes a purchasing unit that transmits the identification information printed on the sample to the computer of the distributor, and
wherein the computer of the distributor includes
a specification unit that specifies the paint and the agency store which prints the sample on the basis of the transmitted identification information,
a charging unit that charges the cost of the specified paint to the purchaser, and
a payment unit that pays the cost of printing the sample to the specified agency store.

2. The paint dealing system according to claim 1,
wherein the computer of the agency store further includes a consumable goods data transmitting unit that transmits consumable goods data for specifying the consumable goods exhausted by printing the sample to the computer of the distributor.

3. The paint dealing system according to claim 1,
wherein the sample printing unit includes a database which specifies a correspondence relationship between the paint and an amount of a coloring material used by the printing apparatus when the sample is printed, and prompts the printing apparatus to print the sample according to the amount of the coloring material obtained by referring to the database.

4. The paint dealing system according to claim 2,
wherein the amount of the coloring material associated with the paint is corrected in each printing apparatus.

5. The paint dealing system according to claim 1,
wherein the computer of the agency store includes a designation unit that indirectly or directly accepts the designation of the paint to be printed as the sample from the purchaser, and
wherein the sample printing unit prompts the printing apparatus to print the designated paint sample.

6. The paint dealing system according to claim 5,
wherein the designation unit accepts the designation of a color from the purchaser so as to designate a paint representing a color approximating the designated color.

7. The paint dealing system according to claim 5,
wherein the designation unit accepts the designation of a color and a light source from the purchaser so as to designate a paint representing a color approximating the designated color under the designated light source.

8. The paint dealing system according to claim 5,
wherein the designation unit accepts the designation of a color from the purchaser by the designation of a colorific value.

9. The paint dealing system according to claim 5,
wherein the designation unit includes an image input apparatus and accepts the designation of a color from the purchaser, and accepts the designation of a color from the purchaser by inputting an object as an image by the image input apparatus to obtain a colorific value.

10. The paint dealing system according to claim 5,
wherein the designation unit includes an image output apparatus, and accepts the designation of a color from the purchaser by the designation of a colorific value of a color represented by the image output apparatus.

11. The paint dealing system according to claim 5,
wherein the designation unit accepts information for specifying the paint purchaser to designate the paint, which is the same or a similar to the paint designated as the designated paint in the past by the paint purchaser.

12. The paint dealing system according to claim 1,
wherein the sample printing unit generates image data corresponding to a printed image when the printing apparatus is prompted to print the sample,
wherein pixels of the image data in a region corresponding to the paint sample have information for uniquely specifying the paint, and
wherein pixels of the image data in a region on which the identification information is recorded have information for specifying the printing color in a predetermined color space.

13. The paint dealing system according to claim 1,
wherein the payment unit changes the amount of a cost of printing the sample according to the quantities of the designated paint.

14. A method of dealing paint using computers which are provided for a purchaser, a distributor, and an agency store and are connected to each other via a communication line, the method comprising:
prompting the computer of the agency store to print a paint sample using a printing apparatus,
prompting the computer of the agency store to print identification information for identifying the paint and the agency store on the sample,
prompting the computer of the purchaser to transmit the identification information printed on the sample to the computer of the distributor,
prompting the computer of the distributor to specify the paint and the agency store printing the sample on the basis of the transmitted identification information,
prompting the computer of the distributor to charge a cost of the specified paint to the purchaser, and
prompting the computer of the distributor to pay a cost of printing the sample to the specified agency store.

15. A computer of a distributor which is connected to a computer of an agency store via a communication line, the computer comprising:
a specification unit that specifies a paint and the agency store in which a sample is printed on the basis of identification information for identifying the agency store and the paint with which the sample is printed by a printing apparatus provided at the computer of the agency store,
a charging unit that charges a cost of the specified paint to the purchaser who purchases the paint, and
a payment unit that pays a cost of printing the sample to the specified agency store.
